(19) United States
(12) Patent Application Publication
(10) Pub. No.: US 2010/0314994 A1
(43) Pub. Date: Dec. 16, 2010

(54) Platinum (II) Isoqulinoline-Pyridine-Benzene Based Complexes, Methods for Making Same, and Organic Light-Emitting Diodes Including Such Complexes

(76) Inventors: Chi Ming CHE, Hong Kong (HK); Chi Fai Kui, Hung Hom (HK); Chi Chung Kwok, Kwai Chung (HK)

Correspondence Address: COOPER & DUNHAM, LLP, 30 Rockefeller Plaza, 20th Floor, NEW YORK, NY, 10112, US

(21) Appl. No.: 12/485,388

(22) Filed: Jun. 16, 2009

(51) Int. Cl. H01J 1/63; B05D 5/06; C07F 15/00

(52) U.S. Cl. 313/504; 427/66; 546/4

(57) ABSTRACT

This invention provides a class of organometallic complexes comprising a tridentate isoquinoline-pyridine-benzene based ligand, a mono-dentate ligand and a platinum (II) center which show high emission quantum efficiency and good thermal stability. This invention also discloses organometallic complexes in organic light-emitting diode (OLED) including them.

### FIELD OF THE INVENTION

This invention relates novel platinum (II) complexes and their usage in organic light-emitting diodes (OLED). The platinum (II) complexes in the invention possess high emission quantum efficiency and good thermal stability. High efficiency single color and white OLEDs (WOLEDs) can be fabricated.

### BACKGROUND OF THE INVENTION

Organic electroluminescence was first observed and studied in the 1960's (U.S. Pat. No. 3,172,862). In the 1980's, a double-layer structure OLEDs (organic light emitting device) was disclosed by Tang (U.S. Pat. No. 4,356,429; Appl. Phys. Lett. 1987, 51, 12, 913). This discovery was based on employing a multilayer structure including an emissive electron-transporting layer and a hole-transport layer of suitable organic materials. Alq₃ (q=deprotonated 8-hydroxyquinolinyl) was chosen as the emissive electron-transporting material. Since then, research on materials used in OLEDs has continued. OLEDs provide several advantages including: (1) low operating voltage; (2) thin, monolithic structure; (3) emitting light, rather than modulating light; (4) good luminous efficiency; (5) full color potential; and (6) high contrast and resolution. These advantages suggest possible use of OLEDs in flat panel displays.

Investigations on organic small molecules have been made in order to improve the performance of OLEDs. In general, fluorescent and phosphorescent materials are employed as light emitters in the emissive layer of OLEDs. Light emission from a fluorescent compound occurs as a result of formation of singlet excitons in the emissive layer of the electroluminescent device. U.S. Published Patent App. No. 2003/178619 B2 says that theoretically 25% singlet excitons and 75% triplet excitons are produced after recombination of holes and electrons in the emissive layer of an electroluminescent device. The singlet excitons transfer their energy to the singlet excited state while the triplet excitons transfer their energy to triplet excited state. Most of the organic small molecules exhibit fluorescence; hence, only 25% of the generated excitons are utilized resulting in the device with low external efficiency.

Electroluminescence from conjugated polymers was first discovered by Friend et al. at Cambridge University during an investigation on the electrical properties of poly(p-phenylene vinylene) (PPV) in 1990 (Nature 1990, 347, 539). Yellow-green light with emission maximum at 551 nm was observed from this bright yellow polymer when excited by a flow of electric current between two electrodes. To deal with the solubility problem, Heeger et al. subsequently fabricated a PLED using soluble PPV derivative. (Appl. Phys. Lett. 1991, 1982).

As PLEDs can be used for large area flat panel displays and are relatively inexpensive, it has been receiving a growing attention in recent years. In the early stage, PLEDs were usually fabricated by spin coating. However, there are many disadvantages associated with this spin coating such as solution wastage and lack of lateral patterning capability, thus limiting the commercial applications of PLEDs. To overcome these drawbacks, inkjet printing has been introduced by Yang et al. (Appl. Phys. Lett. 1998, 2561) and now PLEDs can be fabricated using a commercial available inkjet printer.

In recent years, red-, green- and blue-light emitting polymers have been actively employed for the fabrication of full color panels. However, the commercial applications of the presently known polymers such as poly(p-phenylene) (PPP), PPV, polythiophene (PT), and polyfluorene (PF) are hampered by their oxidative stabilities and/or structural and electronic properties. Although PPV-based materials demonstrate high PL and EL efficiencies and their emission energies are tunable, they usually undergo photo-oxidative degradation upon incorporation into EL devices (Angew. Chem. Int. Ed. 1998, 37, 403). The applications of PPP are limited by its low solubility. PF is a blue-emitting material, which shows good thermal stability and high EL quantum efficiency, but chain aggregation and keto-defect sites in the polymer can cause degradation of EL devices (J. Mater. Chem. 2000, 10, 1471). Also, light-emitting polymers present technical problems in the fabrication of LEDs, including color impurity, imbalanced charge injection, and low EL efficiencies. In contrast to fluorescent compounds, a series of effective phosphorescent iridium complexes with different color emissions has been reported jointly by Thompson et al. at the University of Southern California and Forrest et al. at Princeton University (U.S. Pat. No. 6,515,298; J. Am. Chem., Soc. 2001, 123, 4304; Adv. Mat. 2001, 13, 1245). Che et al. also demonstrated the use of organic metal complexes employing various metal centers such as platinum (II), copper (I), gold (I), and zinc (II) as OLED emitters (U.S. Published Patent Application No. 2005/244672 A1; Chem. Eur. J. 2003, 9, 1263; Chem. Commun., 2002, 206; New J. Chem. 1999, 263; Appl. Phys. Lett., 1999, 74, 1361; Chem. Commun. 1998, 2101; Chem. Commun. 1998, 2491).

Recently, phosphorescent metal-organic materials, which have demonstrated a tremendous success in the development of high performance OLEDs through vacuum deposition process, have been attached to polymer backbones to make new class of light emitting polymers some of the recent examples are: Sky-blue emitting devices by Holdcroft et al. (Macromolecules 2006, 9157) and red-emitting devices by Cao et al. (Organometallics 2007, 26, 3699) In 2006, Thompson and co-workers reported high efficiency green light-emitting PLED with a maximum of external quantum efficiency (EQE) of 10.5%. (Chem. Mater. 2006, 18, 386) Using this method, a near white light-emitting (CIE: 0.30, 0.43) PLED have been fabricated by using a polymer which has attached both blue and red emitting units on it (J. Am. Chem. Soc. 2004, 15388). As the polymeric materials used in the PLEDs have high molecular weight and soluble in common solvents, they are potential candidate for inkjet printing.

### SUMMARY OF THE INVENTION

This invention relates to the preparation and application in organic light-emitting devices (OLEDs) of organometallic complexes having chemical structure of structure I:

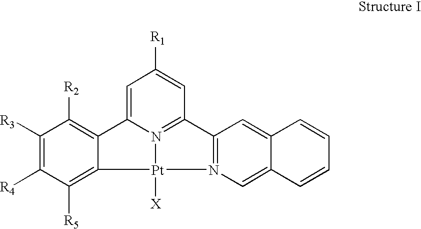

wherein R₁-R₅ are independently hydrogen, halogen, hydroxyl, an unsubstituted alkyl, a substituted alkyl, cycloalkyl, an unsubstituted aryl, a substituted aryl, acyl, alkoxy, acyloxy, amino, nitro, acylamino, aralkyl, cyano, carboxyl, thio, styryl, aminocarbonyl, carbamoyl, aryloxycarbonyl, phenoxycarbonyl, or an alkoxycarbonyl group; X is halogen,

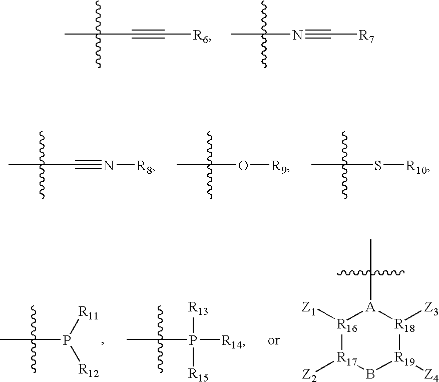

wherein A is carbon, nitrogen, oxygen, silicon, phosphorus, sulphur, arsenic or selenium; B is a chemical bond connecting R₁₇ or R₁₉,

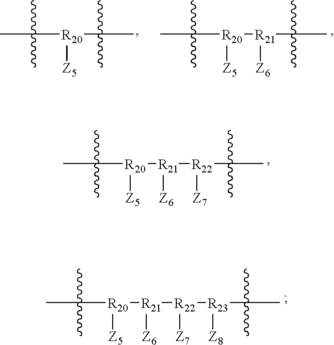

R₆-R₁₅ are independently hydrogen, an alkyl, a substituted alkyl, a cycloalkyl, an aryl, or a substituted aryl group; R₁₆-R₂₃ are independently carbon, nitrogen, oxygen, silicon, phosphorus, sulphur, arsenic or selenium; Z₁-Z₈ are independently hydrogen, an alkyl, a substituted alkyl, a cycloalkyl, an aryl, or a substituted aryl group, and Z₁-Z₈ can form 5-7 member ring(s) with neighboring Zₙ and Rₙ groups. The invention also provides ligands useful for making such complexes.

The invention further provides a method for making such organic metallic complexes, OLEDs incorporating same and methods for making such OLEDs.

The invention also provides compositions useful in making organic metallic complexes, methods for making such complexes, OLEDS including such complexes, and methods for making such OLEDS.

### BRIEF DESCRIPTION OF DRAWINGS AND FIGURES

Further features and advantages of the invention will become apparent by reviewing the following detailed description of the preferred embodiments, taken in conjunction with the attached drawings in which:

FIG. 1 is a schematic drawing of a configuration of organic light-emitting diode;

FIG. 2 is a current density, voltage and brightness (J-V-B) relationship graph for device A;

FIG. 3 is an external quantum efficiency, current density relation graph for device A.

FIG. 4 is an electroluminescence spectrum for device A;

FIG. 5 is a current density, voltage and brightness (J-V-B) relationship graph for device B;

FIG. 6 is an external quantum efficiency, current density relation graph for device B;

FIG. 7 is an electroluminescence spectrum for device B;

FIG. 8 is a current density, voltage and brightness (J-V-B) relationship graph for device C;

FIG. 9 is an external quantum efficiency, current density relation graph for device C;

FIG. 10 is an electroluminescence spectrum for device C;

FIG. 11 is a current density, voltage and brightness (J-V-B) relationship graph for device D;

FIG. 12 is an external quantum efficiency, current density relation graph for device D;

FIG. 13 is an electroluminescence spectrum for device D;

FIG. 14 is a current density, voltage and brightness (J-V-B) relationship graph for device E;

FIG. 15 is an external quantum efficiency, current density relation graph for device E;

FIG. 16 is an electroluminescence spectrum for device E;

FIG. 17 is a current density, voltage and brightness (J-V-B) relationship graph for device F;

FIG. 18 is an external quantum efficiency, current density relation graph for device F.

FIG. 19 is an electroluminescence spectrum for device F;

FIG. 20 is a current density, voltage and brightness (J-V-B) relationship graph for device G;

FIG. 21 is an external quantum efficiency, current density relation graph for device G;

FIG. 22 is an electroluminescence spectrum for device G;

FIG. 23 is a current density, voltage and brightness (J-V-B) relationship graph for device Hp;

FIG. 24 is external quantum efficiency, current density relation graph for device H;

FIG. 25 is an electroluminescence spectrum for device H;

FIG. 26 is a current density, voltage and brightness (J-V-B) relationship graph for device I;

FIG. 27 is external quantum efficiency, current density relation graph for device I; and

FIG. 28 is an electroluminescence spectrum for device I.

### DETAILED DESCRIPTION OF INVENTION

The organometallic complexes with the chemical structure of Structure I are referred to as cyclometallated complexes. The platinum center in Structure I (see above) is in +2 oxidation state and has a square planar geometry.

The coordination sites of the platinum center are occupied by one tridentate ligand and one mono-dentate ligand. The tridentate ligand coordinates to the platinum center through two nitrogen donor bonds and a metal-carbon bond where the nitrogen donors are from pyridine and isoquinoline groups and the metal-carbon bond is formed by benzene or substituted benzene and platinum. The tridentate ligand bears a formal negative charge localized at the site of a metal-carbon bond.

The tridentate ligand is represented by Structure II:

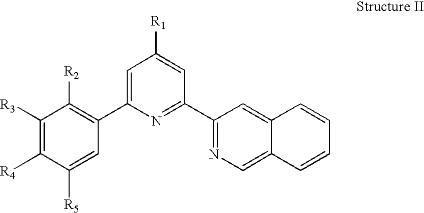

wherein R₁-R₅ are independently hydrogen, halogen, hydroxyl, an unsubstituted alkyl, a substituted alkyl, cycloalkyl, an unsubstituted aryl, a substituted aryl, acyl, alkoxy, acyloxy, amino, nitro, acylamino, aralkyl, cyano, carboxyl, thio, styryl, aminocarbonyl, carbamoyl, aryloxycarbonyl, phenoxycarbonyl, or an alkoxycarbonyl group.

Representative examples of the tridentate ligand are shown below:

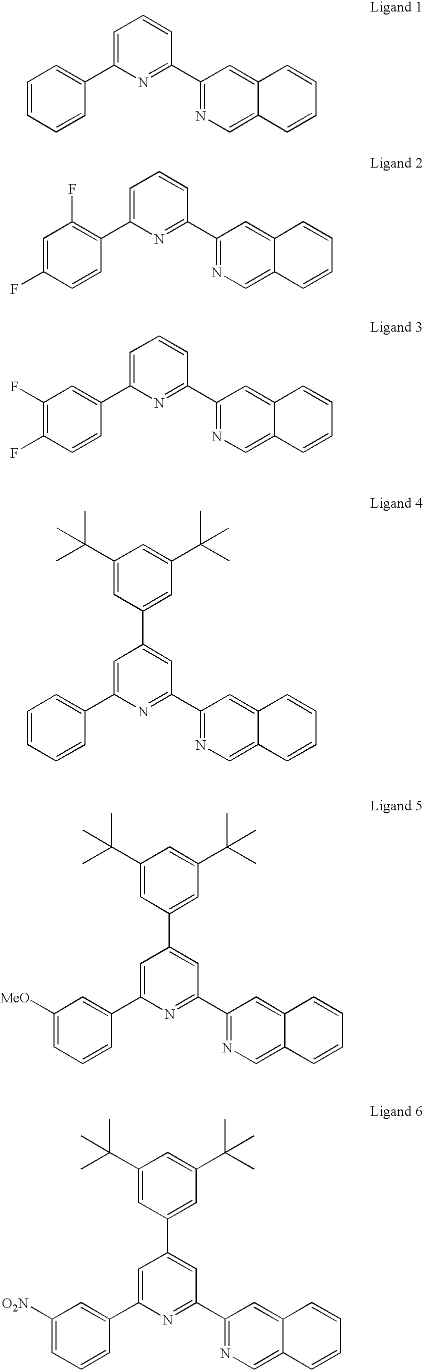

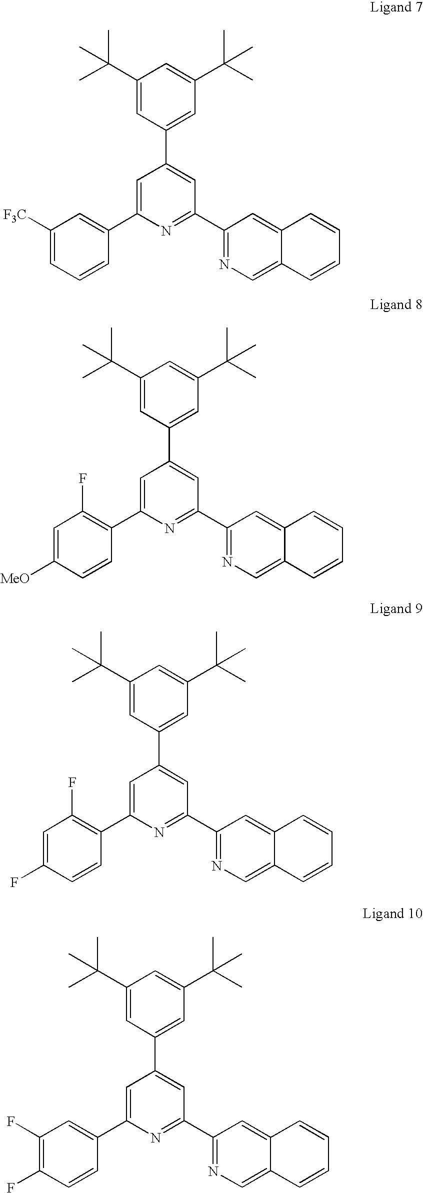

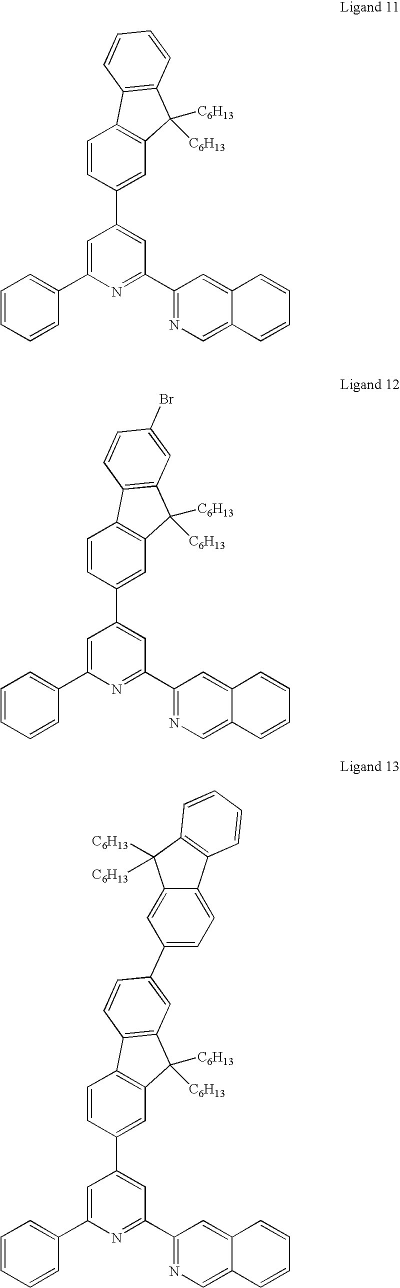

Representative examples of the platinum (II) complexes (Complexes 1-16) based on Structure I are shown below:

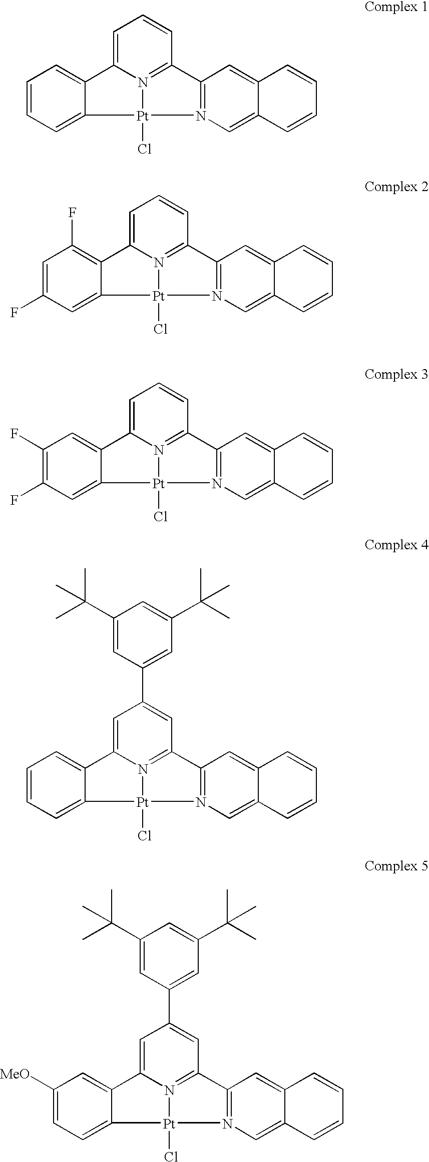

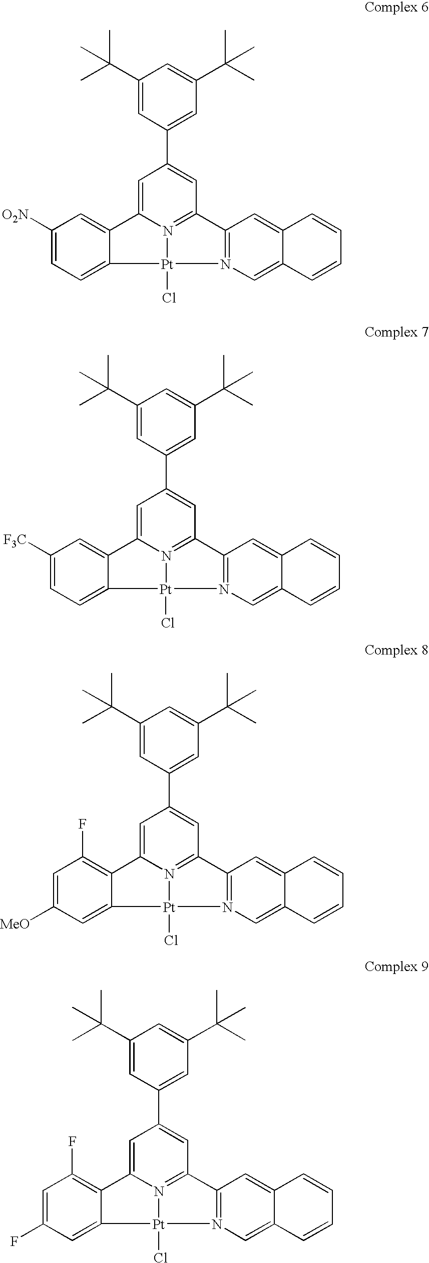

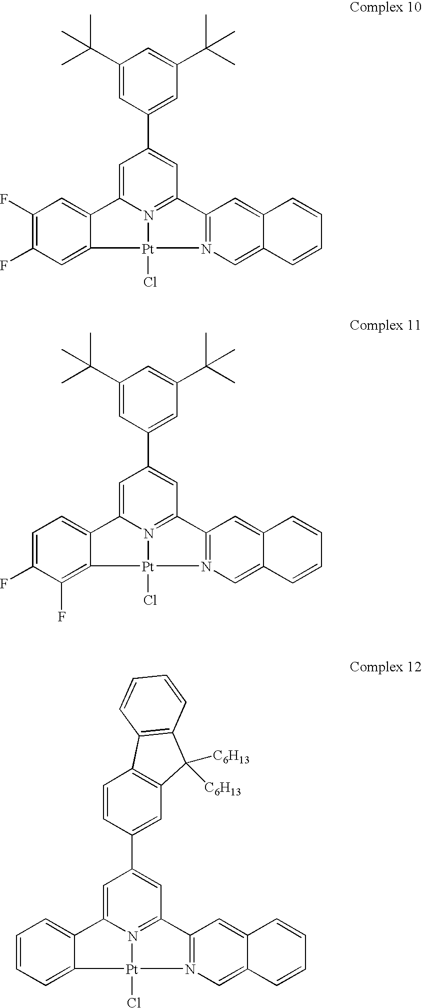

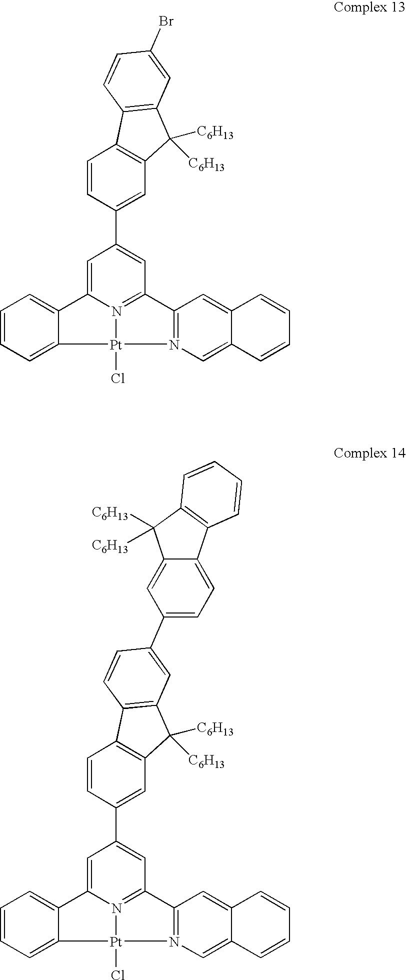

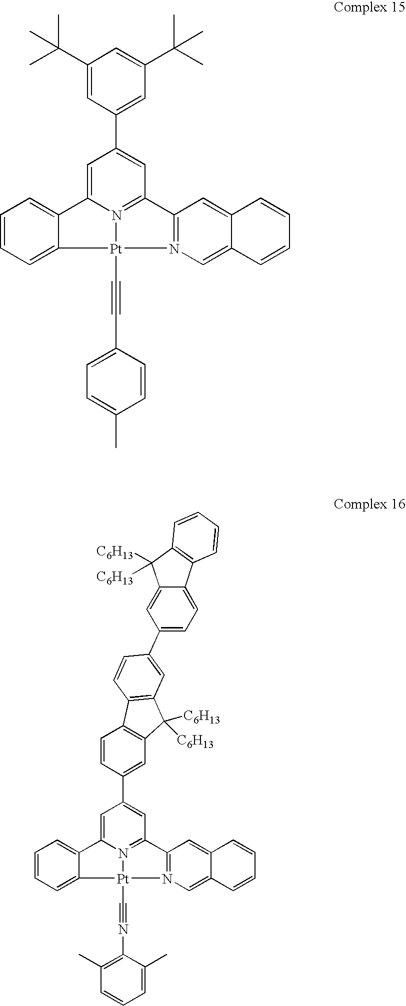

In preferred embodiments, there is a general method for preparing platinum (II) complexes with corresponding ligands (Ligands 1-13) in the representative examples. To prepare of these platinum (II) complexes a mixture of potassium tetrachloroplatinate (K₂PtCl₄) and ligand (Ligands 1-13) in glacial acetic acid was refluxed for 24 hours gave a yellow suspension. The yellow solid was washed with water and acetone, and recrystallized in CH₂Cl₂ or DMF. Reaction I below illustrates the preferred use of acetic acid as solvent in forming neutral platinum complexes.

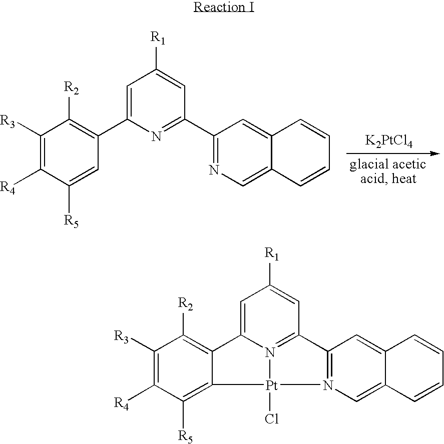

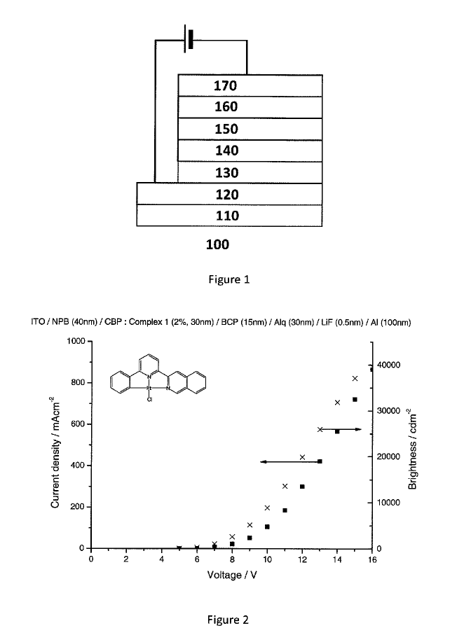

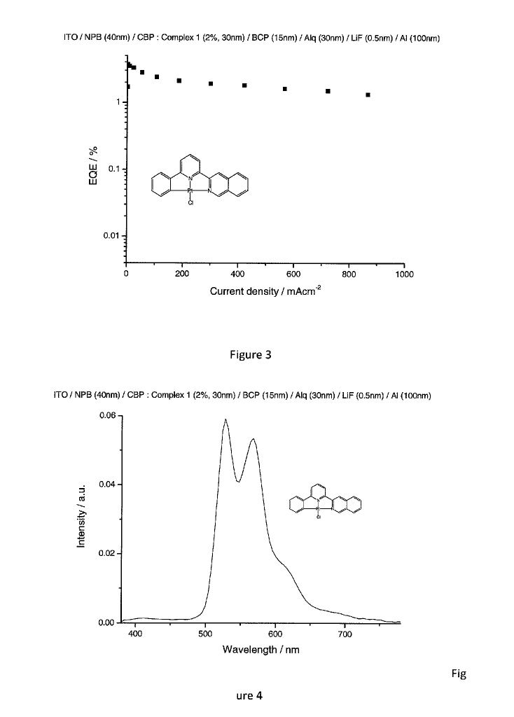

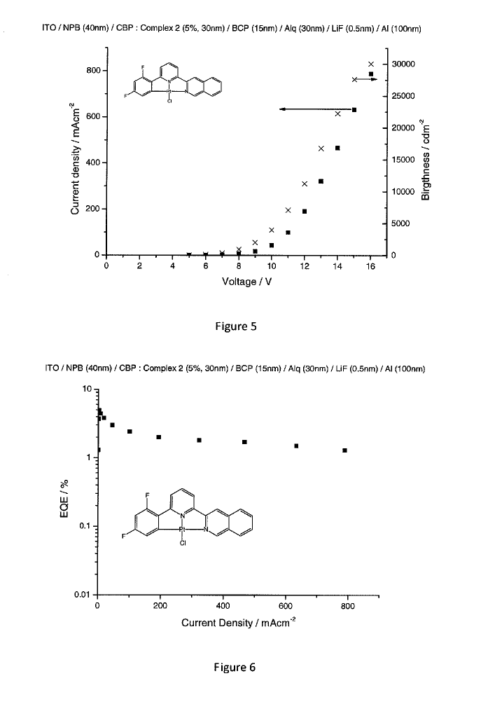

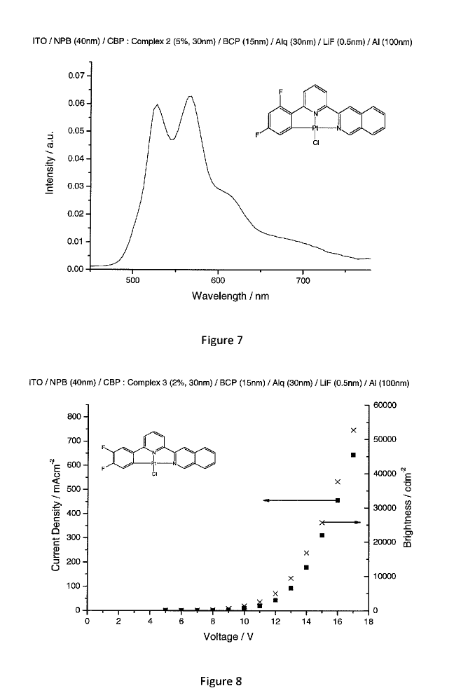

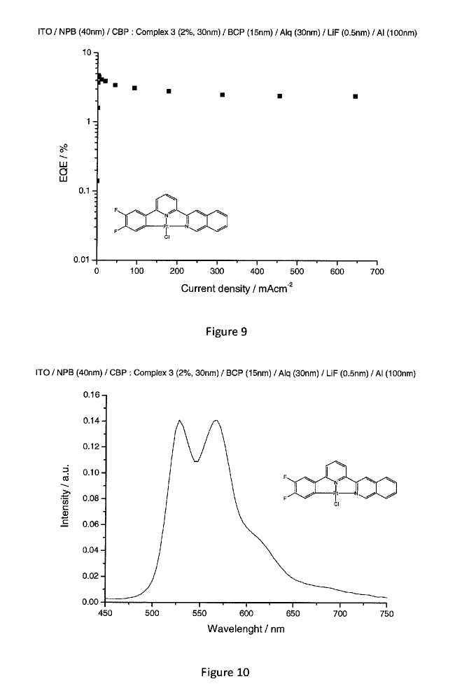

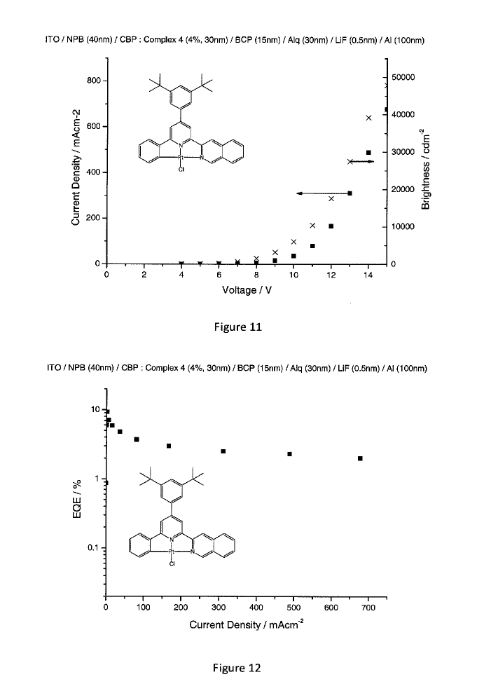

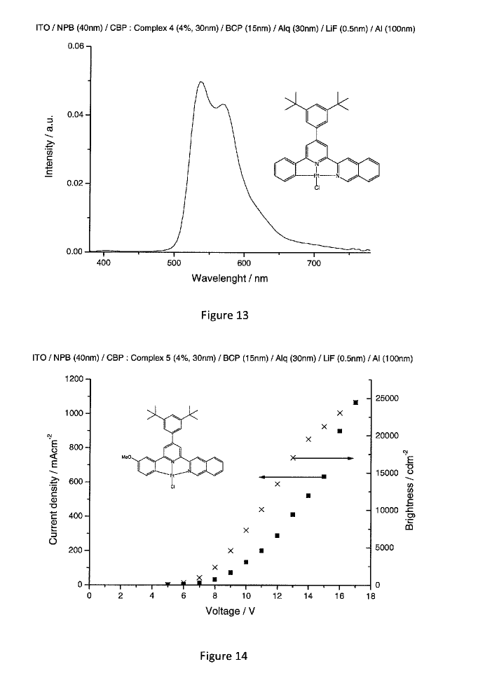

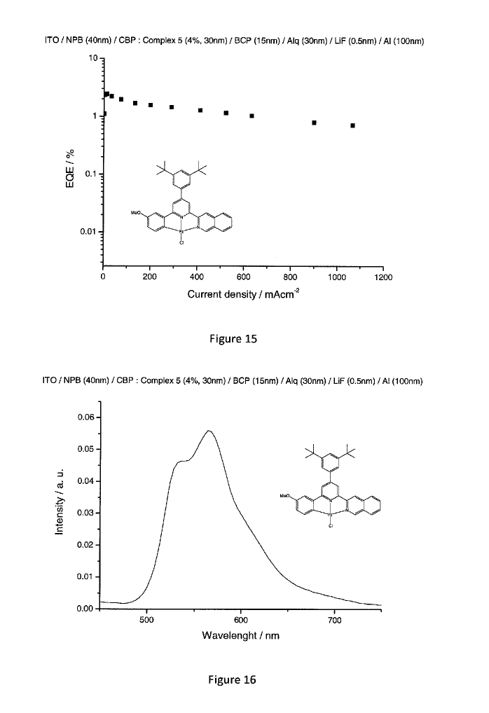

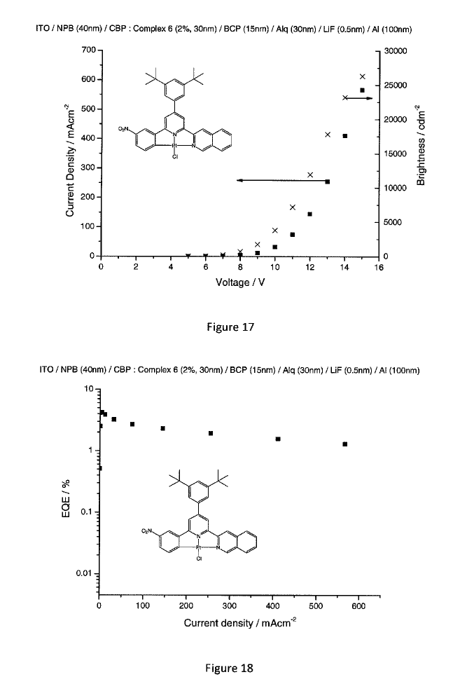

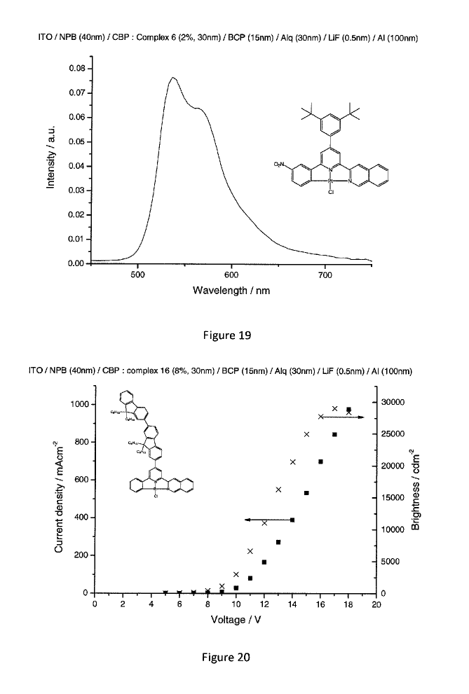

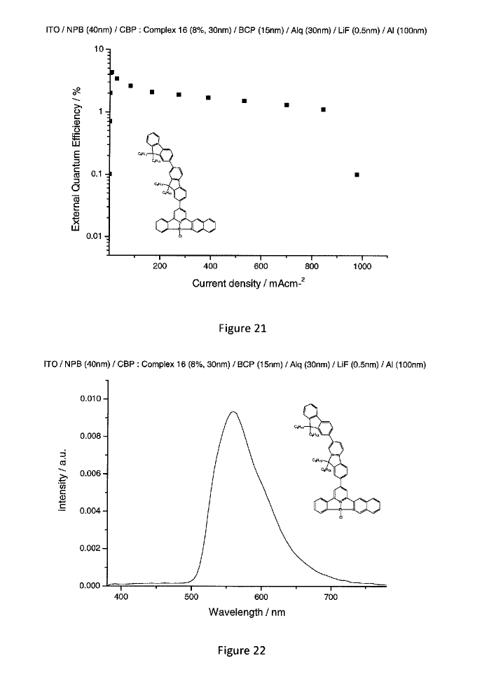

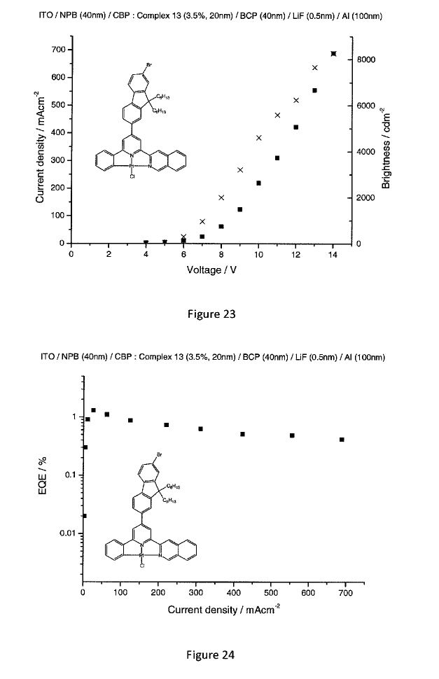

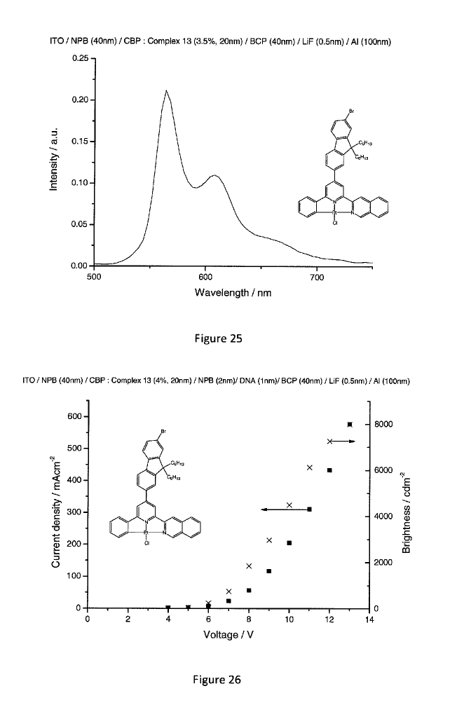

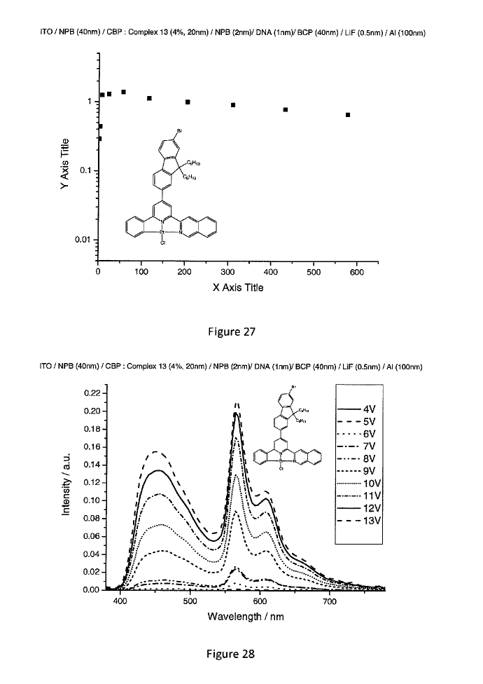

The present invention also relates to OLED comprising at least one emissive layer containing organometallic complex with chemical structure of Structure I. As shown in FIG. 1, a typical device 100 has a transparent anode layer 120; a cathode layer 170; emissive layer 140; optional hole transporting layer 130; optional hole blocking layer 150 and optional electron transporting layer 160. Layer 110 is transparent substrate, it can be glass or plastic; rigid or flexible substrate.

The organometallic complexes of the invention are used in emissive layer 140. Layer 140 can be purely comprised of organometallic complex in the invention (100 weight % of organometallic complex) or mixing with host material in certain weight %. Preferably, the host material transport hole and/or electron and have wider band gap than the organometallic complexes in the invention. The host material can be polymeric material such as but not limited to poly(N-vinyl carbazole), polysilane and polyfluorene. It can also be a small molecule such as but not limited to CBP (4,4′-N,N′-dicarbazole-biphenyl) or tertiary aromatic amines.

The transparent anode layer (layer 120) can be made of materials containing metal, alloy, metal oxide or mixed-metal oxide such as indium-tin-oxide.

The hole transport layer (layer 130) is fabricated by organic materials such as but not limited to TPD (N,N′-Bis(3-methylphenyl)-N,N′-diphenylbenzidine), NPB (N,N′-di-1-naphthyl-N,N′-diphenyl-benzidine), TAPC (1,1-bis[(di-4-tolylamino)phenyl]cyclohexane), ETPD (N,N′-bis(4-methylphenyl)-N,N′-bis(4-ethylphenyl)-[1,1′-(3,3′-dimethyl)biphenyl]4,4′-di amine, CuPc (copper phthalocyanine), PVK (polyvinylcarbazole) and PEDOT (poly(3,4-ethylendioxythiophene).

The hole blocking layer (layer 150) is fabricated from organic materials with high electron mobility and low HOMO (highest occupied molecular orbital) level such as but not limited to BCP (2,9-dimethyl-4,7-diphenyl-1,10-phenanthroline, bathocuproine) and BAlq₃ (bis(2-methyl-8-quinolinolato)(4-phenylphenolato)aluminum).

The electron transporting layer (layer 160) is fabricated by organic materials with high electron mobility such as but not limited to Alq₃ (tris(8-quinolinolato)aluminum), BAlq₃ (bis(2-methyl-8-quinolinolato)(4-phenylphenolato)aluminum), PBD (2-(4-biphenylyl)-5-(4-tert-butylphenyl)-1,3,4-oxadiazole) and TAZ (3-(4-biphenylyl)-4-phenyl-5-(4-tert-butylphenyl)-1,2,4-triazole).

The cathode (layer 170) is fabricated by low work function metal such as but not limited to Ca, Al and Ba.

### EXAMPLES

A number of examples are listed below to further illustrate the invention. They should not be construed to limit the invention in any way.

### Example 1

Synthetic Procedure for Ligand 1:

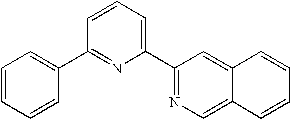

Refluxing a methanol (100 mL) solution of 1.00 g (2.64 mmol) 1-(2-oxo-2-(3′-isoquinolinyl)ethyl)pyridinium iodide, 0.60 g (2.81 mmol) 3-Dimethylamino-1-(2′-pyridinyl)-propanone hydrochloride salt and 5.00 g (64.9 mmol) ammonium acetate for 24 hours give a suspension solution. The crude product was filtered from the solution mixture, washed with water and cold methanol, and purified by column chromatography. Yield: 0.64 g (86.0%). ¹H NMR (500 MHz, CDCl₃) δ=7.45 (t, J=7.2 Hz, 1H), 7.55(t, J=7.2 Hz, 2H), 7.63 (t, J=7.3 Hz, 1H), 7.65 (t, J=7.8 Hz 1H), 7.78 (d, J=7.5 Hz, 1H), 7.93 (t, J=7.8 Hz, 1H), 8.02 (d, J=8.6 Hz, 2H), 8.21 (d, J=6.3 Hz, 2H), 8.49 (d, J=7.8 Hz, 1H), 9.01 (s, 1H), 9.34 (s, 1H). EI-MS (+ve, m/z): 282 [M⁺].

### Example 2

Synthetic Procedure for Ligand 2:

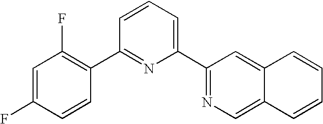

A solution of 3-acetylisoquinoline (0.84 g, 4.94 mmol) and potassium tert-butoxide (0.83 g, 7.40 mmol) in THF (30 ml) was stirred for 2 hr at room temperature to give a yellow suspension. A solution of 1-N,N-dimethylamino-3-(2′,4′-difluorophenyl)-3-oxo-1-propene (1.04 g, 4.94 mmol) in THF (20 ml) was then added and the mixture was stirred for 12 hr at room temperature to give a dark red solution. A solution of ammonium acetate (26.0 g, 0.34 mol) in acetate acid (100 ml) was added to the mixture. THF was removed by distillation over 2 hr and the residue was dried under vacuum. Dichloromethane (50 ml) was added to yield a red solution, which was neutralized with saturated sodium bicarbonate solution then extracted with CH₂Cl₂. The organic extract was dried over sodium sulphate. Purification was performed by silica gel chromatography using n-hexane: ethyl acetate (9:1) as eluent to give pale yellow solid. Yield: 0.94 (60%) ¹H NMR (500 MHz, CDCl₃) δ=7.09 (m, 1H), 7.11 (m, 1H), 7.62 (t, J=5.51 Hz, 1H), 7.71 (t, J=8.05 Hz, 1H), 7.78 (d, J=7.78 Hz, 1), 7.92 (t, J=7.83 Hz, 1H), 8.00 (d, J=8.30 Hz, 1H), 8.01 (d, 8.2 Hz, 1H), 8.26 (m, 1H), 8.50 (d, J=7.6 Hz, 1H), 8.90 (s, 1H), 9.34 (s, 1H). EI-MS (+ve, m/z): 319.2[M⁺].

### Example 3

Synthetic Procedure for Ligand 3:

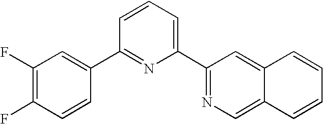

A solution of 3-acetylisoquinoline (1.00 g, 5.84 mmol) and potassium tert-butoxide (0.98 g, 8.76 mmol) in THF (30 ml) was stirred for 2 hr at room temperature to give a yellow suspension. A solution of 1-N,N-dimethylamino-3-(3′,4′-difluorophenyl)-3-oxo-1-propene (1.23 g, 5.84 mmol) in THF (20 ml) was then added and the mixture was stirred for 12 hr at room temperature to give a dark red solution. A solution of ammonium acetate (26.0 g, 0.34 mol) in acetate acid (100 ml) was added to the mixture. THF was removed by distillation over 2 hr and the residue was dried under vacuum. Dichloromethane (50 ml) was added to yield a red solution, which was neutralized with saturated sodium bicarbonate solution then extracted with CH₂Cl₂. The organic extract was dried over sodium sulphate. Purification was performed by silica gel chromatography using n-hexane: ethyl acetate (9:1) as eluent to give pale yellow solid. Yield: 0.93 g (50%). ¹H NMR (500 MHz, CDCl₃, 25° C.). δ=7.32 (q, 1H), 7.65 (t, 1H), 7.72 (d, 1H), 7.75 (t, 1H), 7.90 (m, 1H), 8.00 (t, 2H), 8.11 (t, 1H), 8.51 (d, 1H), 8.96 (s, 1H), 9.34 (s, 1H). ¹³C NMR (150 MHz, CDCl₃, 25° C.): δ=156.3, 154.4, 152.1, 149.7, 140.0, 136.6, 130.6, 128.9, 127.8, 127.7, 127.6, 122.9(3), 122.8, 120.0, 119.6, 117.8, 117.4 (d, J=17.25 Hz), 116.1 (d, J=18.15 Hz) EI-MS (+ve, m/z): 319.1[M⁺].

### Example 4

General Synthetic Procedures for Ligands 4-10.

Refluxing a methanol mixture of 1-(2-oxo-2-(3′-isoquinolinyl)ethyl)pyridinium iodide, excess ammonium acetate and the corresponding α,β-unsaturated ketone for 24 hours gave a suspension mixture. The crude product was filtered from the solution mixture, washed with water and cold methanol, and purified by column chromatography (silica gel, n-hexane/Et₂O=8:1 as eluent).

### Example 5

Synthetic Procedure for Ligand 4:

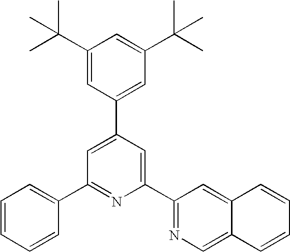

Ligand 4 was synthesized by general procedures in Example 4 with 1.00 g (2.64 mmol) 1-(2-oxo-2-(3′-isoquinolinyl)ethyl)pyridinium iodide, 0.85 g (2.65 mmol) 3′,5′-di-tert-butylbenzylidene-2-acetophenone, 5.00 g (64.9 mmol) ammonium acetate and 100 mL methanol. Ligand 4 was obtained as yellow solid. Yield 1.11 g (89.0%). ¹H NMR (500 MHz, CDCl₃, 25° C.) δ=1.47 (s, 18H), 7.51 (m, 1H), 7.58 (m, 3H), 7.65 (t, J=7.8 Hz, 3H), 7.75 (t, J=7.8 Hz, 1H,), 7.90 (s, 1H), 8.01 (m, 2H), 8.23 (d, J=7.5 Hz, 2H), 8.80 (s, 1H), 9.10 (s, 1H), 9.32 (s, 1H). ¹³C NMR (500 MHz, CDCl₃, 25° C.): δ=31.6, 35.1, 118.1, 118.3, 118.9, 121.7, 123.1, 127.3, 127.5, 127.6, 127.8, 128.3, 128.6, 128.8, 129.0, 130.5, 133.1, 136.7, 138.7, 139.9, 150.3, 151.9. 152.0, 156.5. EI-MS (+ve, m/z): 471 [M⁺].

### Example 6

Synthetic Procedure for Ligand 5:

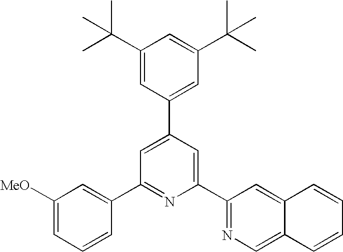

Ligand 5 was synthesized by general procedures in Example 4 with 0.75 g (1.97 mmol) 1-(2-oxo-2-(3′-isoquinolinyl)ethyl)pyridinium iodide, 0.69 g (1.97 mmol) 3′,5′-di-tert-butylbenzylidene-2-(1-aceto-3-methoxyphenone), 5.00 g, (64.9 mmol) ammonium acetate and 100 mL methanol. Ligand 5 was obtained as yellow solid. Yield 0.81 g (82.0%). ¹H NMR (500 MHz, CDCl₃, 25° C.) δ=1.47 (s, 18H), 3.97 (s, 3H), 7.10 (d, J=9.4 Hz, 1H), 7.52 (t, J=7.8 Hz, 1H), 7.61 (s, 1H), 7.65 (s, 2H), 7.68 (t, J=7.8 Hz, 1H), 7.79 (t, J=7.8 Hz, 1H), 7.82 (d, J=7.5 Hz, 1H), 7.87 (s, 1H), 7.97 (s, 1H), 8.04 (d, J=8.6 Hz, 2H), 8.72 (s, 1H), 9.00 (s, 1H), 9.35 (s, 1H). ¹³C NMR (500 MHz, CDCl₃, 25° C.): δ=31.6, 35.1, 55.5, 113.2, 114.3, 118.1, 118.5, 119.1, 119.8, 121.7, 123.1, 127.5, 127.6, 127.8, 128.8, 129.8, 130.5, 136.7, 138.7, 141.5, 150.3, 151.6, 151.9, 152.0. EI-MS (+ve, m/z): 501 [M⁺].

### Example 7

Synthetic Procedure for Ligand 6:

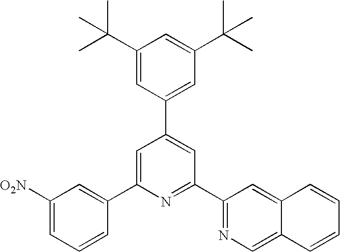

Ligand 6 was synthesized by general procedures in Example 4 with 1.32 g (3.51 mmol) 1-(2-oxo-2-(3′-isoquinolinyl)ethyl)pyridinium iodide, 1.28 g (3.5 mmol) (E)-3-(3,5-di-tert-butylphenyl)-1-(3-nitrophenyl)prop-2-en-1-one, 5.00 g (64.9 mmol) ammonium acetate and 100 mL methanol. Ligand 6 was obtained as yellow solid. Yield: 1.12 g (62%). ¹H NMR (600 MHz, CDCl₃, 25° C.) [symbol] =1.44 (s, 18H), 7.59 (d, J=1.5 Hz, 1H), 7.61 (d, J=1.62 Hz, 2H), 7.66 (t, J=7.80 Hz), 7.75 (m, 2H), 7.98 (d, J=1.2 Hz, 1H), 8.06 (d, J=8.10 Hz, 1H), 8.09 (d, J=8.16 Hz, 1H), 8.34 (d, J=6.12 Hz, 1H), 8.60 (d, J=7.68 Hz, 1H), 8.81 (s, 1H), 9.04 (s, 1H). 9.12 (t, J=1.62 Hz, 1H), 9.38 (s, 1H). FAB-MS (+ve, m/z): 516.4[M⁺].

### Example 8

Synthetic Procedure for Ligand 7:

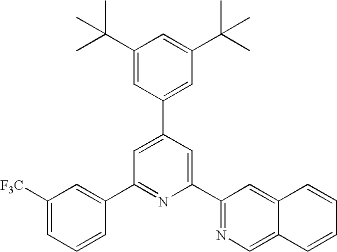

Ligand 7 was synthesized by general procedures in Example 4 with 0.87 g (2.3 mmol) 1-(2-oxo-2-(3′-isoquinolinyl)ethyl)pyridinium iodide, 0.89 g (2.3 mmol) 3′,5′-di-tert-butylbenzylidene-2-(1-aceto-3-trifluromethylphenone), 5.00 g (64.9 mmol) ammonium acetate and 100 mL methanol. Ligand 7 was obtained as yellow solid. Yield 1.05 g (85.0%). ¹H NMR (500 MHz, CDCl₃, 25° C.). [symbol] =1.47 (s, 18H), 7.60 (s, 1H), 7.63 (s, 2H), 7.68 (t, J=7.8 Hz, 1H), 7.72 (t, J=7.8 Hz, 1H), 7.80 (m, 2H), 8.00 (s, 1H), 8.10 (t, J=8.4 Hz 2H), 8.47 (d, J=7.5 Hz, 1H), 8.55 (s, 1H), 8.80 (s, 1H), 9.00 (s, 1H), 9.35 (s, 1H). ¹³C NMR (500 MHz, CDCl₃, 25° C.): [symbol] =31.6, 35.1, 118.2, 119.0, 121.7, 123.3, 124.1, 124.2, 125.4, 125.5, 127.6, 127.7, 127.9, 128.9, 129.2, 130.5, 130.6, 130.9, 131.1, 131.4, 131.6, 136.7, 138.5, 140.7, 150.0, 152.1, 151.6. EI-MS (+ve, m/z): 539 [M⁺].

### Example 9

Synthetic Procedure for Ligand 8:

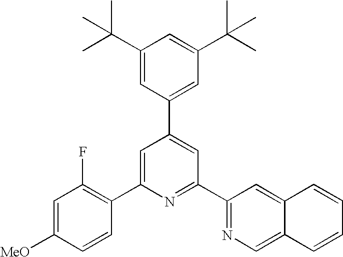

Ligand 8 was synthesized by general procedures in Example 4 with 0.62 g (1.62 mmol) 1-(2-oxo-2-(3′-isoquinolinyl)ethyl)pyridinium iodide, 0.52 g (1.62 mmol)(E)-3-(3,5-di-tert-butylphenyl)-(2-fluoro-4methoxyphenyl)prop-2-en-1-one, 5.00 g, (64.9 mmol) ammonium acetate and 100 mL methanol. Ligand 8 was obtained as yellow solid. Yield: 0.50 g (60.0%). ¹H NMR (500 MHz, CDCl₃). [symbol] =1.42 (s, 18H), 3.90 (s, 3H), 6.76 (d, J=13 Hz, 1H), 6.93 (d, J=6.68 Hz), 7.54 (s, 1H), 7.62 (m, 3H), 7.72 (t, J=7.25 Hz, 1H), 8.00 (m, 3H), 8.27 (t, J=8.9 Hz, 1H), 8.70 (d, J=1.2 Hz, 1H), 8.98 (s, 1H), 9.37 (s, 1H). ¹³C NMR (500 MHz, CDCl₃): [symbol] =31.7, 35.1, 55.7, 101.9, 102.1, 110.7, 117.9, 120.4, 121.8, 122.2, 123.0, 127.5, 127.8, 128.8, 130.5, 131.9, 132.0, 136.7, 138.6, 150.3, 151.4, 152.0, 153.1, 156.4, 160.6, 161.4, 161.5, 162.6. EI-MS (+ve, m/z): 519.4 [M⁺].

### Example 10

Synthetic Procedure for Ligand 9:

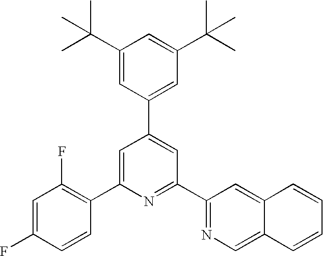

Ligand 9 was synthesized by general procedures in Example 4 with 1.00 g (2.66 mmol) 1-(2-oxo-2-(3′-isoquinolinyl)ethyl)pyridinium iodide, 0.95 g (2.66 mmol) 3-(2,4-di-tert-butylphenyl)-(3,4-difluorophenyl)prop-2-en-1-one, 5.00 g, (64.9 mmol) ammonium acetate and 100 mL methanol. Ligand 9 was obtained as yellow solid. Yield: 1.35 g (70%).

### Example 11

Synthetic Procedure for Ligand 10:

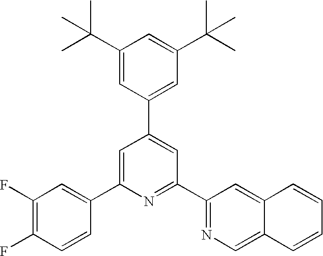

Ligand 10 was synthesized by general procedures in Example 4 with 1.48 g (3.93 mmol) 1-(2-oxo-2-(3′-isoquinolinyl)ethyl)pyridinium iodide, 1.40 g (3.93 mmol) 3-(3,5-di-tert-butylphenyl)-(3,4-difluorophenyl)prop-2-en-1-one, 5.00 g, (64.9 mmol) ammonium acetate and 100 mL methanol. Ligand 10 was obtained as yellow solid. Yield: 1.60 g (80.0%). ¹H NMR (500 MHz, CDCl₃). δ=1.43 (s, 18 H), 7.30-7.36 (m, 1H), 7.56 (s, 1H), 7.59 (s, 2H), 7.63 (t, J=7.2 Hz, H), 7.77 (t, J=8.0 Hz, H), 7.86 (s, 1H, H), 7.94-7.97 (m, 1H), 8.03 (d, J=7.7 Hz, 1H), 8.06 (d, J=7.8 Hz, 1H), 8.14-8.18 (m, 1H), 8.74 (s, 1H), 9.00 (s, 1H, H), 9.37 (s, 1H, H). 13C NMR (126 MHz, CDCl₃,25° C.):δ=31.7, 35.1, 116.3, 116.4, 117.4, 117.5, 118.1, 118.4, 118.8, 121.7, 12 3.0, 123.2, 127.6, 128.9, 130.6, 136.6, 137.0, 138.4, 149.8, 151.7, 151.8, 152.0, 152.2, 154.9, 156.7. ¹⁹F NMR (376 MHz, CDCl₃, 25° C.): δ=−137.4, −137.7. FAB-MS (+ve, m/z): 507 [M⁺].

### Example 12

Synthetic Procedure for Ligand 11:

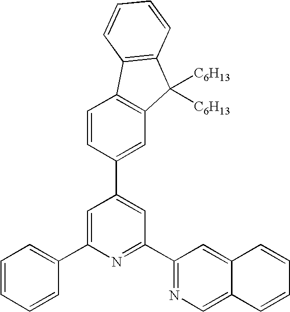

Ligand 11 was synthesized by general procedures in Example 4 with 3.83 g (8.97 mmol) 1-(2-oxo-2-(3′-isoquinolinyl)ethyl)pyridinium iodide, 4.20 g (8.89 mmol) (E)-3-(9,9-dihexyl-9H-fluoren-2-yl)-1-phenylprop-2-en-1-one, 7.1 g (91 mmol) ammonium acetate and 550 mL methanol/dichloromethane (10:1 by volume) mixture. Ligand 11 was obtained as yellow oil. Yield: 4.35 g (82%). ¹H NMR (400 MHz, CDCl₃): δ 9.39 (s, 1H), 9.07 (s, 1H), 8.82 (s, 1H), 8.28 (d, J=7.3 Hz, 2H), 8.03-8.06 (m, 3H), 7.84 (s, 2H), 7.73-7.79 (m, 3H), 7.64 (t, J=7.0 Hz, 1H), 7.58 (t, J=7.5 Hz, 2H), 7.49 (t, J=7.5 Hz, 2H), 7.35-7.39 (m, 3H), 2.04-2.12 (m, 4H), 1.11-1.23 (m, 12H), 0.73-0.89 (m, 10H). FAB-MS (m/z): 614 [M⁺].

### Example 13

Synthetic Procedure for Ligand 12:

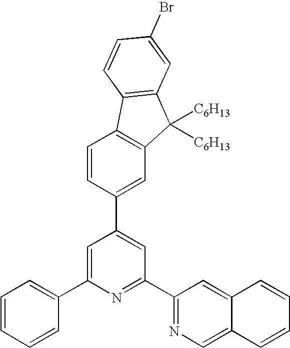

Ligand 12 was synthesized by general procedures in Example 4 with 3.83 g (8.97 mmol) 1-(2-oxo-2-(3′-isoquinolinyl)ethyl)pyridinium iodide, 4.88 g (8.97 mmol) (E)-3-(7-bromo-9,9-dihexyl-9H-fluoren-2-yl)-1-phenylprop-2-en-1-one, 15.4 g, (0.20 mmol) ammonium acetate and 100 mL methanol/chloroform (10:1 by volume) mixture. Ligand 12 was obtained as yellow oil. Yield: 4.52 g (73%). ¹H NMR (400 MHz, CDCl₃): δ 9.39 (s, 1H), 9.08 (s, 1H), 8.81 (s, 1H), 8.28 (d, J=8.5 Hz, 2H), 8.05 (d, J=8.9 Hz, 2H), 8.01 (s, 1H), 7.74-7.86 (m, 4H), 7.61-7.67 (m, 2H), 7.59 (t, J=7.6 Hz, 2H), 7.49-7.51 (m, 3H), 2.01-2.10 (m, 4H), 1.06-1.18 (m, 12H), 0.65-0.86 (m, 10H). FAB-MS (m/z): 694 [M⁺].

### Example 14

Synthetic Procedure for Ligand 13:

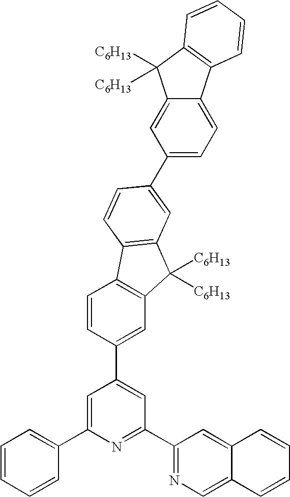

2 M aqueous Na₂CO₃ solution (15 mL) were injected to a degassed toluene solution (150 mL) of 1.03 g (1.48 mmol) Ligand 12, 0.17 g (0.154 mmol) tetrakis(triphenylphosphine)palladium(0) and 0.68 g, (1.48 mmol) 9,9-Di-n-hexylfluoren-2-yl-4,4,5,5-tetramethyl-[1,3,2]dioxaborolane by a syringe. The reaction mixture was stirred with 80° C. for 12 h. The product was extracted with dichloromethane (3×100 mL), washed with water, and dried over MgSO₄. After evaporation of the solvent, the residue was purified by flash chromatography on silica gel using CH₂Cl₂ as eluent to obtain Ligand 13 as pale yellow oil. Yield: 0.89 g, 64%. ¹H NMR (400 MHz, CDCl₃): δ 9.40 (s, 1H), 9.09 (s, 1H), 8.85 (s, 1H), 8.30 (d, J=7.6 Hz, 2H), 8.04-8.06 (m, 3H), 7.63-7.88 (m, 12H), 7.59 (t, J=7.6 Hz, 2H), 7.50 (t, J=7.6 Hz, 1H), 7.30-7.38 (m, 3H), 2.12-2.17 (m, 4H), 2.02-2.07 (m, 4H), 1.02-1.18 (m, 24H),0.72-0.83 (m, 20H). FAB-MS (m/z): 947 [M⁺].

### Example 15

General Synthetic Procedure for Complexes 1-14.

A mixture of K₂PtCl₄ and ligands 1-9 in glacial acetic acid (100 ml) was refluxed for 48 hours to give complexes 1 to 9 as a yellow suspension. The yellow solid was filtered, washed with water and acetone and recrystallized in DMF.

### Example 16

Synthetic Procedure for Complex 1:

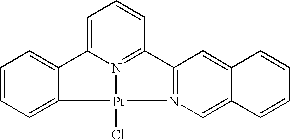

Complex 1 was synthesized by general procedures in Example 15 with 0.42 g (1.01 mmol) K₂PtCl₄, 0.23 g (0.82 mmol) Ligand 4 and 100 ml glacial acetic acid. Complex 1 was obtained as yellow crystalline solid. Yield: 0.34 g (80.0%). ¹H NMR (400 MHz, DMF, 25° C.):δ=7.12 (t, J=6.9 Hz, 1H), 7.20 (t, J=6.9 Hz, 1H), 7.68 (d, J=6.6 Hz, 1H), 7.73 (d, J=7.5 Hz, 1H), 7.97 (m, 1H), 8.11 (t, J=7.3 Hz 1H), 8.22 (m, 4H), 8.54 (d, J=7.5 Hz, 1H), 9.15 (s, 1H), 9.75 (s, 1H). ¹³C NMR (500 MHz, CDCl₃, 25° C.): δ=119.4, 123.1, 124.4, 125.2, 128.8, 130.0, 130.3, 130.7, 130.9, 131.4, 134.5, 135.3, 136.7, 140.1, 143.7, 148.0, 151.0, 152.7, 155.6, 163.2. FAB-MS (+ve, m/z): 512 [M⁺].

### Example 17

Synthetic Procedure for Complex 2:

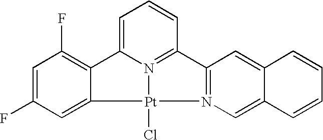

Complex 2 was synthesized by general procedures in Example 15 with 0.49 g (1.17 mmol) K₂PtCl₄, 0.31 g (0.98 mmol) Ligand 2 and 100 ml glacial acetic acid. Complex 2 was obtained as yellow crystalline solid. Yield: 0.43 g (80.0%). ¹H NMR (500 MHz, DMF) δ [symbol] 7.37 (t, J=8.44 Hz, 1H), 7.44 (t, J=9.98 Hz, 1H), 8.03 (d, J=7.75 Hz, 1H), 8.11 (m, 1H), 8.32 (t, J=7.6 Hz), 8.44 (d, J=8.15 Hz, 1H), 8.67 (t, J=7.85 Hz, 1H), 8.73 (d, J=7.95 Hz, 1H), 8.92 (d, J=8.13 Hz), 9.44 (s, 1H), 10.39 (s, 1H). ¹³C NMR (500 MHz, CDCl₃): δ=103.9, 104.0, 111.5, 121.8, 123.4, 128.4, 129.6, 130.2, 131.5, 134.0, 134.6, 135.9, 140.3, 151.2, 153.2, 157.4, 159.9, 162.7, 163.0, 164.1.

### Example 18

Synthetic Procedure for Complex 3:

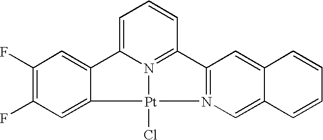

Complex 3 was synthesized by general procedures in Example 15 with 0.78 g (1.88 mmol) K₂PtCl₄, 0.50 g (1.57 mmol) Ligand 3 and 100 ml glacial acetic acid. Complex 3 was obtained as yellowish green crystalline solid. Yield: 0.69 g (80.0%). FAB-MS (+ve, m/z): 512 [M-Cl⁺].

### Example 19

Synthetic Procedure for Complex 4:

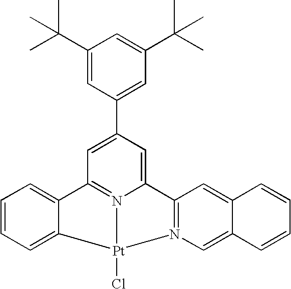

Complex 4 was synthesized by general procedures in Example 15 with 0.31 g (0.75 mmol) K₂PtCl₄, 0.29 g (0.62 mmol) Ligand 4 and 100 ml glacial acetic acid. Complex 4 was obtained as yellow crystalline solid. Yield: 0.39 g (90.0%). ¹H NMR (400 MHz, DMF, 25° C.): δ=1.47 (s, 18H), 7.10 (m, 2H), 7.67 (d, J=6.6 Hz, 1H), 7.77 (s, 1H), 7.79 (d, J=6.7 Hz, 1H), 7.92 (t, J=7.3 Hz, 1H), 7.97 (s, 2H), 8.08 (t, J=7.6 Hz, 1H), 8.12 (d, J=4.2 Hz, 2H), 8.39 (d, J=8.1 Hz, 1H), 8.54 (s, 1H), 9.27 (s, 1H), 9.65 (s, 1H). ¹³C NMR (500 MHz, CDCl₃, 25° C.): δ=31.5, 35.7, 117.4, 117.8, 122.7, 123.3, 123.4, 124.2, 124.7, 125.5, 128.7, 129.9, 130.2, 130.4, 131.2, 134.3, 135.2, 136.7, 137.9, 143.7, 148.2, 151.2, 152.5, 152.9, 155.5, 162.3. FAB-MS (+ve, m/z): 700 [M⁺].

### Example 20

Synthetic Procedure for Complex 5:

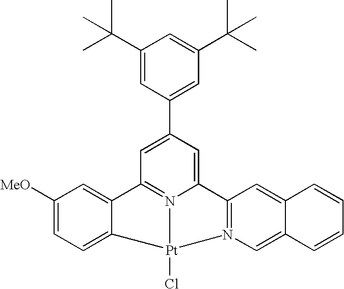

Complex 5 was synthesized by general procedures in Example 15 with 0.37 g (0.90 mmol) K₂PtCl₄, 0.28 g (0.54 mmol) ligand 5 and 100 ml glacial acetic acid. Complex 5 was obtained as yellow crystalline solid. Yield: 0.28 g (70.0%). ¹H NMR (500 MHz, DMF, 25° C.): δ=1.47 (s, 18H), 3.93 (s, 3H), 6.90 (d, J=7.7 Hz, 1H), 7.54 (s, 1H), 7.60 (d, J=8.3 Hz, 1H), 7.73 (s, 1H), 7.95 (m, 3H), 8.12 (t, J=7.5 Hz, 1H), 8.17 (d, J=8.1 Hz, 1H), 8.33 (s, 1H), 8.52 (d, J=8.1 Hz, 1H), 8.58 (s, 1H), 9.32 (s, 1H), 9.75 (s, 1H). ¹³C NMR (500 MHz, DMF, 25° C.): δ=31.6, 35.7, 111.6, 116.7, 117.7, 118.0, 122.8, 123.4, 124.7, 128.7, 129.9, 130.3, 131.3, 133.5, 134.3, 135.8, 136.6, 138.0, 148.7, 151.2, 152.3, 152.4, 153.1, 155.6, 158.1, 162.5 FAB-MS (+ve, m/z): 730 [M⁺].

### Example 21

Synthetic Procedure for Complex 6:

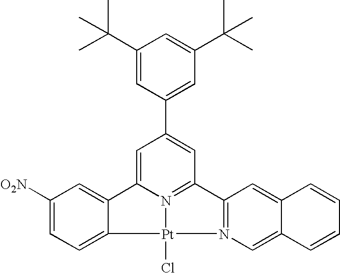

Complex 6 was synthesized by general procedures in Example 15 with 0.17 g (0.45 mmol) K₂PtCl₄, 0.18 g (0.35 mmol) ligand 6 and 100 ml glacial acetic acid. Complex 6 was isolated as a yellow crystalline solid. Yield: 0.23 g (90.0%). ¹H NMR (500 MHz, CD₂Cl₂, 25° C.): [symbol] =1.50 (s, 18H), 7.12 (s, 1H), 2.93 (m, 2H,), 7.44 (d, J=7.55 Hz, 1H), 7.55 (t, J=6.85 Hz, 1H), 7.66 (s, 2H), 7.70 (m, 3H), 7.76 (t, J=7.15 Hz, 1H), 7.81 (d, J=8.05 Hz, 1H), 8.13 (s, 1H), 8.91 (s, 1H). FAB-MS (+ve, m/z): 745.2[M⁺].

### Example 22

Synthetic Procedure for Complex 7:

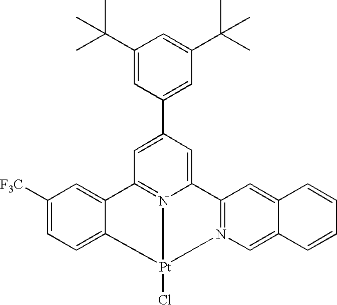

Complex 7 was synthesized by general procedures in Example 15 with 0.19 g (0.46 mmol) K₂PtCl₄, 0.20 g (0.38 mmol) ligand 9 and 100 ml glacial acetic acid. Complex 5 was obtained as yellow crystalline solid. Yield: 0.20 g (70.0%). ¹H NMR (500 MHz, DMF, 25° C.): δ=1.47 (s, 18H), 7.37 (d, J=7.7 Hz, 1H), 7.75 (s, 1H), 7.80 (d, J=7.8 Hz, 1H), 7.90 (t, J=7.1 Hz, 1H), 7.98 (s, 2H), 8.10 (m, 2H), 8.30 (d, J=8.0 Hz, 1H), 8.40 (s, 2H), 8.60 (s, 1H), 9.25 (s, 1H), 9.50 (s, 1H). ¹³C NMR (500 MHz. DMF, 25° C.): δ=31.5, 35.7, 117.6, 118.4, 118.7, 121.4, 121.7, 121.9, 122.1, 122.9, 123.3, 123.7, 124.9, 125.6, 126.4, 127.1, 128.8, 130.0, 131.4, 134.1, 134.5, 135.3, 136.7, 137.7, 142.3, 146.2, 146.9, 162.7. FAB-MS (+ve, m/z): 768 [M⁺].

### Example 23

Synthetic Procedure for Complex 8:

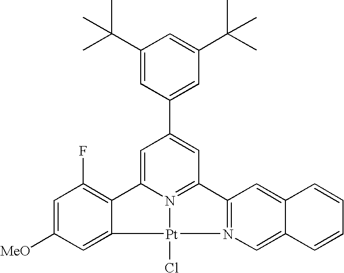

Complex 8 was synthesized by general procedures in Example 15 with 0.17 g (0.45 mmol) K₂PtCl₄, 0.44 g (0.86 mmol) ligand 8 and 100 ml glacial acetic acid. Complex 8 was obtained as orange crystalline solid. Yield: 0.52 g (80.0%). ¹H NMR (500 MHz, DMF, 25° C.): δ=1.64 (s, 18H), 3.73 (s, 3H), 6.59 (d, J=14.1 Hz, 1H), 7.00 (d, J=2.4 Hz, 1H), 7.80 (s, 1H), 7.90 (t, J=1.6 Hz 1H), 8.00 (t, J=7.8 Hz, 1H), 8.04 (d, J=1.7 Hz, 2H), 8.21 (m, 1H), 8.27 (d, J=4.05 Hz, 1H), 8.29 (d, J=4.3 Hz, 1H), 8.49 (s, 1H), 9.28 (s, 1H), 9.59 (s, 1H). ¹³C NMR (126 MHz, DMF, 25° C.): δ=30.0, 35.2, 97.4, 115.6, 116.7, 119.2, 119.3, 122.2, 123.0, 124.2, 126.7, 128.3, 129.2, 129.5, 130.7, 133.8, 136.2, 137.9, 145.9, 151.0, 152.0, 152.1, 155, 160.1, 162.1, 162.4, 162.6, 163.2, 163.8. FAB-MS (+ve, m/z): 748.2[M⁺].

### Example 24

Synthetic Procedure for Complex 9:

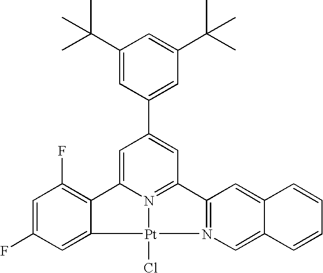

Complex 9 was synthesized by general procedures in Example 15 with 0.49 g (1.18 mmol) K₂PtCl₄, 0.50 g (0.99 mmol) ligand 9 and 100 ml glacial acetic acid. Complex 8 was obtained as orange crystalline solid. Yield: 0.58 g (80.0%). ¹H NMR (500 MHz, CD₂Cl₂, 25° C.): δ=1.48 (s, 18H), 6.39-6.44 (m, 1H), 6.97 (d, J=8.5 Hz, 1H), 7.63-7.67 (m, 5H), 7.73 (d, J=8.2 Hz), 7.80-7.83 (m, 2H), 7.91 (d, J=8.2 Hz, H), 8.33 (s, 1H), 9.24 (s, 1H). ¹³C NMR (126 MHz, CD₂Cl₂, 25° C.): δ=31.4, 35.2, 99.0, 99.2, 116.7, 116.8, 120.1, 120.3, 121.8, 121.9, 124.3, 127.9, 128.7, 129.2, 130.2, 133.2, 135.7, 137.4, 150.6, 152.1, 152.2, 152.6, 154.4. ¹⁹F NMR (400 MHz, CD₂Cl₂, 25° C.): δ=−105.9, −111.3.

### Example 25

Synthetic Procedure for Complex 10:

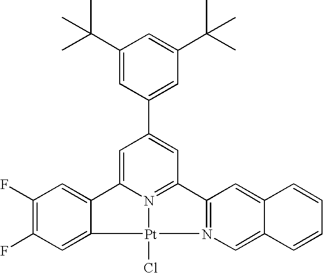

Complex 10 was synthesized by general procedures in Example 15 with 0.93 g (2.37 mmol) K₂PtCl₄, 1.00 g (1.97 mmol) ligand 10 and 100 ml glacial acetic acid. Complex 10 was obtained as yellow solid. Yield: 0.87 g (60.0%). ¹H NMR (500 MHz, CD₂Cl₂, 25° C.): δ=1.49 (s, 18H), 6.97-7.01 (m, 1H), 7.06-7.10 (m, 2H), 7.60-7.68 (m, 5H), 7.74 (s, 1H), 7.83 (t, J=8.1 Hz, H), 7.92 (d, J=8.1 Hz, H), 8.25 (s, 1H), 9.17 (s, 1H). ¹³C NMR (126 Hz, CD₂Cl₂, 25° C.): δ=31.4, 35.2, 112.3, 112.4, 116.5, 117.1, 121.7, 121.9, 122.0, 124.4, 127.8, 127.9, 128.6, 129.1, 130.2, 133.2, 135.5, 137.2, 139.1, 150.4, 152.0, 152.3, 152.4, 154.6, 163.0. ¹⁹F NMR (400 MHz, CDCl₃, 25° C.): δ=−134.3, −146.0. FAB-MS (+ve, m/z): 700 [M-Cl]⁺.

### Example 26

Synthetic Procedure for Complex 11:

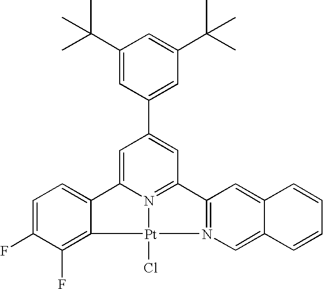

Complex 11 was synthesized by general procedures in Example 15 with 0.93 g (2.37 mmol) K₂PtCl₄, 1.00 g (1.97 mmol) ligand 10 and 100 ml glacial acetic acid. Complex 11 was obtained as yellow solid. Yield: 0.44 g (30.0%). ¹H NMR (500 MHz, CD₂Cl₂, 25° C.): δ=1.54 (s, 18H), 6.80 (m, 1H), 7.18 (m, 1H), 7.39 (s, 1H), 7.65 (s, 2H), 7.68 (s, 1H), 7.69 (t, J=7.2 Hz, 1H), 7.82 (s, 1H), 7.87 (m, 2H), 7.98 (d, J=8.1 Hz, 1H), 8.36 (s, 1H), 9.59 (s, 1H). ¹³C NMR (126 MHz, CD₂Cl₂, 25° C.): δ=31.4, 35.2, 112.1, 112.3, 116.9, 117.3, 120.8, 121.6, 121.7, 124.5, 127.9, 129.0, 129.1, 130.4, 133.6, 135.7, 137.2, 150.7, 151.3, 152.3, 152.7, 154.7, 163.9. ¹⁹F NMR (376 MHz, CDCl₃, 25° C.): −121.9, −132.5. FAB-MS (+ve, m/z): 700 [M-Cl]⁺.

### Example 27

Synthetic Procedure for Complex 12:

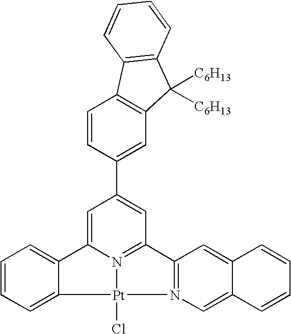

Complex 12 was synthesized by general procedures in Example 15 with 0.71 g (1.71 mmol) K₂PtCl₄, 1.05 g (1.71 mmol) ligand 11 and 50 ml glacial acetic acid. Complex 12 was obtained as yellow solid. Yield: 1.3 g (86%). ¹H NMR (400 MHz, CD₂Cl₂): δ9.70 (s, 1H), 8.51 (s, 1H), 8.11 (d, J=8.0 Hz, 1H), 8.04 (d, J=8.2 Hz, 1H), 7.98 (s, 1H), 7.92-7.96 (m, 2H), 7.785-7.85 (m, 3H), 7.69 (t, J=6.4 Hz, 1H), 7.50 (d, J=7.5 Hz, 1H), 7.39-7.45 (m, 3H), 7.18 (t, J=6.4 Hz, 1H), 7.13 (t, J=7.5 Hz, 1H), 2.08-2.16 (m, 4H), 1.08-1.39 (m, 12H), 0.69-0.89 (m, 10H). FAB-MS (m/z): 844 [M⁺].

### Example 28

Synthetic Procedure for Complex 13:

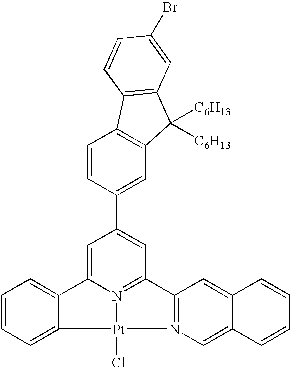

Complex 13 was synthesized by general procedures in Example 15 with 0.71 g (1.71 mmol) K₂PtCl₄, 1.19 g (1.71 mmol) ligand 12 and 50 ml glacial acetic acid. Complex 13 was obtained as yellow solid. Yield: 1.3 g (86%). ¹H NMR (400 MHz, CD₂Cl₂): δ9.33 (s, 1H), 8.39 (s, 1H), 7.86-7.93 (m, 5H), 7.82 (t, J=7.5 Hz, 1H), 7.72-7.76 (m, 2H), 7.55-7.63 (m, 3H), 7.47 (d, J=7.4 Hz, 1H), 7.30 (s, 1H), 7.23 (d, J=7.0 Hz, 1H), 6.99 (t, J=7.2 Hz, 1H), 6.94 (t, J=7.2 Hz, 1H), 2.19-2.25 (m, 2H), 2.02-2.13 (m, 2H), 2.02-2.09 (m, 4H), 1.11-1.22 (m, 12H), 0.72-0.81 (m, 10H). FAB-MS (m/z): 923 [M⁺].

### Example 29

Synthetic Procedure for Complex 14:

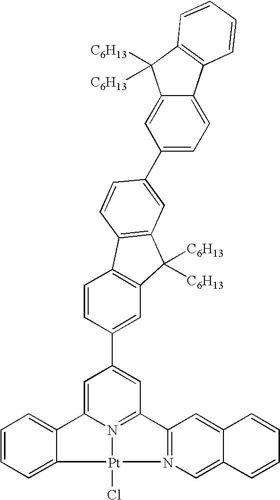

Complex 14 was synthesized by general procedures in Example 15 with 0.71 g (1.71 mmol) K₂PtCl₄, 1.62 g (1.71 mmol) ligand 9 and 50 ml glacial acetic acid. Complex 9 was obtained as orange solid. Yield: 1.3 g, 86%. ¹H NMR (400 MHz, CD₂Cl₂): δ9.56 (s, 1H), 8.48 (s, 1H), 7.83-8.02 (m, 8H), 7.64-7.77 (m, 6H), 7.60-7.63 (m, 2H), 7.57 (s, 1H), 7.49 (t, J=7.3 Hz, 1H), 7.42 (m, 1H), 7.37 (t, J=7.5 Hz, 1H), 7.08 (m, 2H), 2.23-2.33 (m, 2H), 2.06-2.15 (m, 2H), 1.01-1.38 (m, 12H), 0.76-0.87 (m, 10H). FAB-MS (m/z): 1177 [M⁺].

### Example 30

Synthetic Procedure for Complex 15:

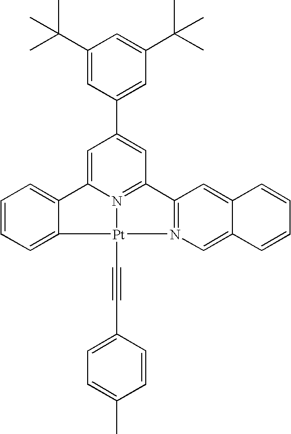

Complex 4 (0.17 g, 0.24 mmol), 1-ethyl-4-methylbenzene (0.18 ml, 1.43 mmol) and triethylamine (1 ml, 6.68 mmol) were dissolved in a solution of acetonitrile: dichloromethane (3:1) (30 ml). CuI (5 mg) was added to the reaction mixture as a catalyst. The yellow mixture was stirred under nitrogen for 48 hr at room temperature. The orange solid was then filtered and washed with cold acetonitrile and diethyl ether. Then the solid was dry to give orange complex 15. Yield: 0.16 g (84%). FAB-MS (+ve, m/z): 779 [M⁺].

### Example 31

Example 31 illustrates general procedures for preparing OLEDs in present invention. The OLEDs were prepared on patterned indium-tin-oxide (ITO) glass with a sheet resistance of 20Ω/. Thermal vacuum deposition of the materials was carried out sequentially under a vacuum of 1×10⁻⁶ torr in a thin film deposition system (MBraun three-glove box system integrated with an Edwards Auto 306 deposition system). The devices were encapsulated using anodized aluminum caps and their performance was examined using Photoresearch PR-650. The current-voltage characteristics were studied using a Keithley 2400 sourcemeter. The OLEDs employing Complexes 1-9 have the following configuration: ITO (indium tin oxide)/NPB (4,4′-bis[N-(1-naphthyl)-N-phenylamino]biphenyl, 40 nm)/CBP (4,4′-N,N′-dicarbazolebiphenyl): Complexes 1-6 and 14, X %, 30 nm)/BCP (bathocuprine, 15 nm)/AlQ (tris(8-quinolinolato)aluminum, 30 nm)/LiF (0.5 nm)/Al (100 nm).

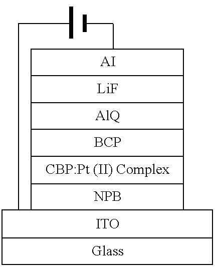

### Example 32

Example 22 illustrates the devices performance of OLED devices fabricated by the method stated in Example 21 using complexes 1-6 and 9 as emitting materials.

| | | | Bₘₐₓ/ | | ηₘₐₓ/ | ηₘₐₓ/ | |
|---|---|---|---|---|---|---|---|
| Device | Complex | Conc.ₒₚₜᵢₘᵤₘ/% | cdm⁻² | CIE | cdA⁻¹ | luW⁻¹ | EQEₘₐₓ/% |
| A | 1 | 2 | 39632 | 0.39, 0.57 | 13.2 | 6.9 | 3.7 |
| B | 2 | 5 | 30048 | 0.38, 0.59 | 15.7 | 8.2 | 5.0 |
| C | 3 | 2 | 52728 | 0.37, 0.59 | 16.3 | 7.0 | 4.8 |
| D | 4 | 4 | 50848 | 0.40, 0.58 | 28.6 | 12.9 | 9.3 |
| E | 5 | 4 | 30024 | 0.41, 0.56 | 8.0 | 3.6 | 2.4 |
| F | 6 | 2 | 26296 | 0.37, 0.61 | 21.6 | 8.5 | 6.5 |
| G | 14 | 8 | 29016 | 0.44, 0.54 | 13.9 | 5.5 | 4.2 |

### Example 33

Example 33 illustrates general procedures for preparing OLEDs in present invention. The OLEDs were prepared on patterned indium-tin-oxide (ITO) glass with a sheet resistance of 20Ω/. Thermal vacuum deposition of the materials was carried out sequentially under a vacuum of 1×10⁻⁶ torr in a thin film deposition system (MBraun three-glove box system integrated with an Edwards Auto 306 deposition system). The devices were encapsulated using anodized aluminum caps and their performance was examined using Photoresearch PR-650. The current-voltage characteristics were studied using a Keithley 2400 sourcemeter. The OLEDs employing Complexes 1-9 have the following configuration: ITO (indium tin oxide)/NPB (4,4′-bis[N-(1-naphthyl)-N-phenylamino]biphenyl, 40 nm)/CBP (4,4′-N,N′-dicarbazolebiphenyl): Complexes 13, 3.5%, 20 nm)/BCP (bathocuprine, 40 nm)/LiF (0.5 nm)/Al (100 nm) (device H). FIG. 21 shows J-V-B curves of device H. The threshold voltage of is <54 V for 1 cd/m2. Device H shows maximum luminance of 8270 cd m⁻² at 14 V.

### Example 34

Example 34 illustrates general procedures for preparing a WOLED (device I) in present invention. The WOLED was prepared on patterned indium-tin-oxide (ITO) glass with a sheet resistance of 20Ω/. Thermal vacuum deposition of the materials was carried out sequentially under a vacuum of 1×10⁻⁶ torr in a thin film deposition system (MBraun three-glove box system integrated with an Edwards Auto 306 deposition system). The devices were encapsulated using anodized aluminum caps and their performance was examined using Photoresearch PR-650. The current-voltage characteristics were studied using a Keithley 2400 sourcemeter. The WOLEDs employing Complex have the following configuration: ITO (indium tin oxide)/NPB (4,4′-bis[N-(1-naphthyl)-N-phenylamino]biphenyl, 40 nm)/CBP (4,4′-N,N′-dicarbazolebiphenyl): Complexes 12, 4.2%, 20 nm)/NPB, (2 nm)/9,10-bis-(□-naphthyl)-anthrene (DNA, 1 nm)/BCP (bathocuprine, 40 nm)/LiF (0.5 nm)/Al (100 nm) (device I). FIG. 24 shows J-V-B curves of device I. The threshold voltage of is <5 V for 1 cd/m2. Device H shows maximum luminance of 7996 cd m⁻² at 13 V and CIE of (0.32, 0.31).

The references acted throughout this application are incorporated herein by reference.

1. An organometallic complex having a chemical structure of structure I: 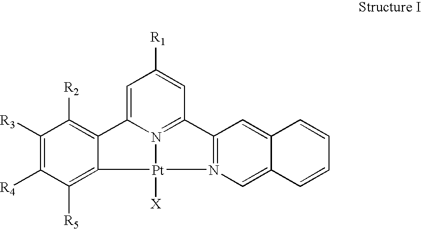
wherein R₁-R₅ are independently hydrogen, halogen, hydroxyl, an unsubstituted alkyl, a substituted alkyl, cycloalkyl, an unsubstituted aryl, a substituted aryl, acyl, alkoxy, acyloxy, amino, nitro, acylamino, aralkyl, cyano, carboxyl, thio, styryl, aminocarbonyl, carbamoyl, aryloxycarbonyl, phenoxycarbonyl, or an alkoxycarbonyl group; X is halogen, 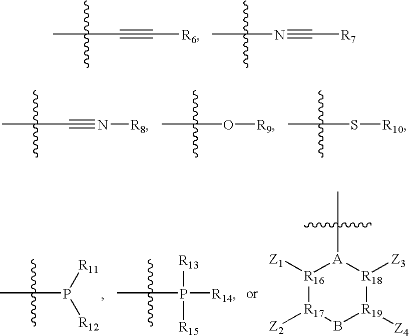
wherein A is carbon, nitrogen, oxygen, silicon, phosphorus, sulphur, arsenic or selenium; B is a chemical bond connecting R₁₇ and R₁₉, 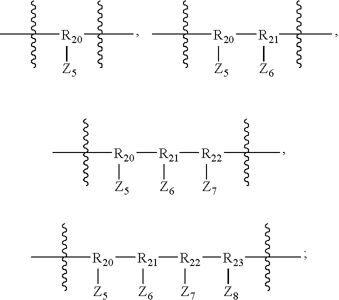
R₆-R₁₅ are independently hydrogen, alkyl, substituted alkyl, cycloalkyl, aryl, or substituted aryl group; R₁₆-R₂₃ are independently carbon, nitrogen, oxygen, silicon, phosphorus, sulphur, arsenic or selenium; Z₁-Z₈ are independently hydrogen, alkyl, substituted alkyl, cycloalkyl, aryl, or a substituted aryl group and Z₁-Z₈ can form 5-7 member ring(s) with neighboring Zₙ and Rₙ groups.

2. The organometallic complex of claim 1 wherein Structure I is one of the following compounds:

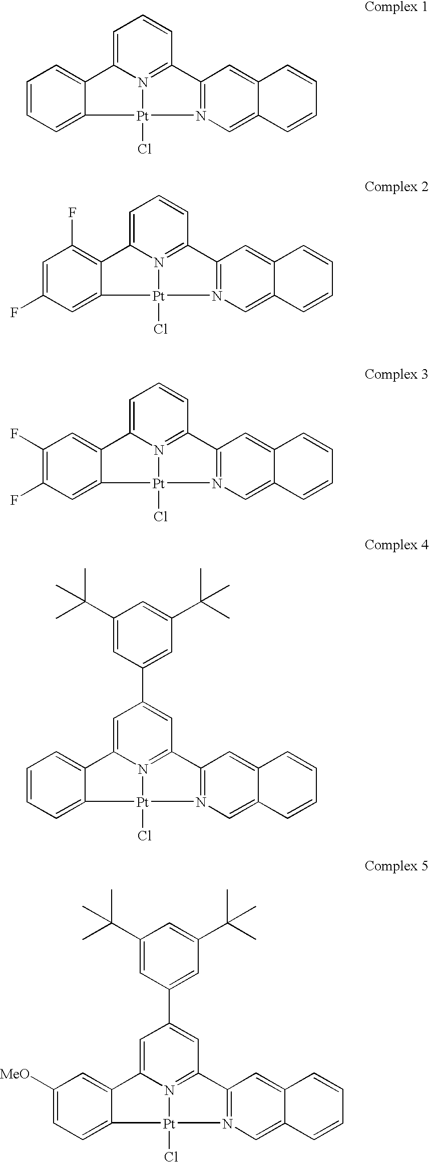

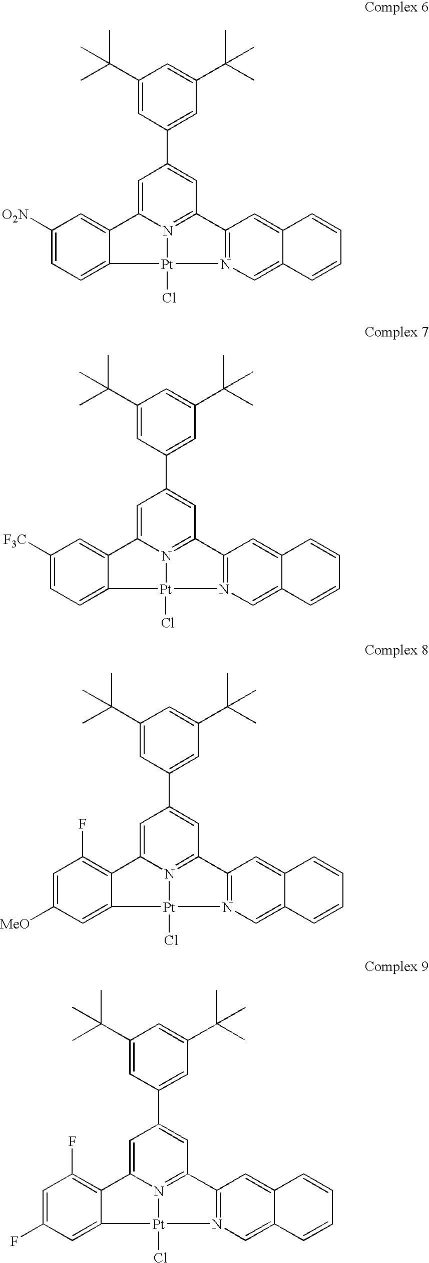

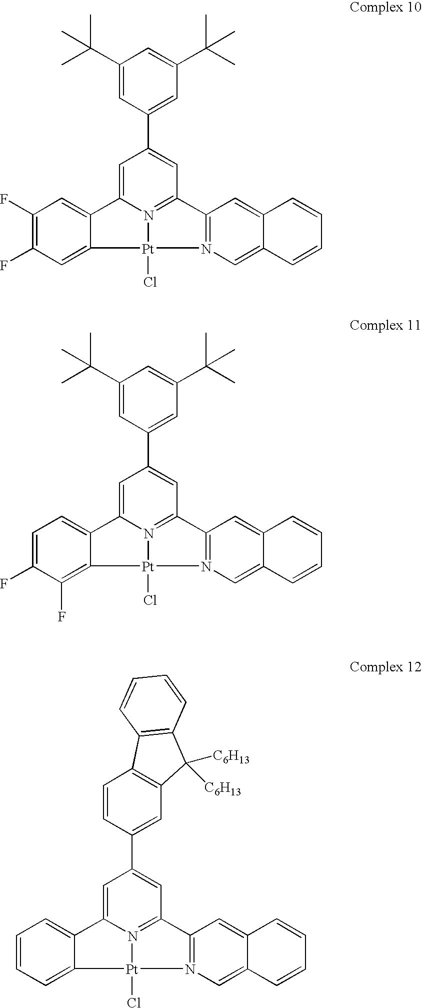

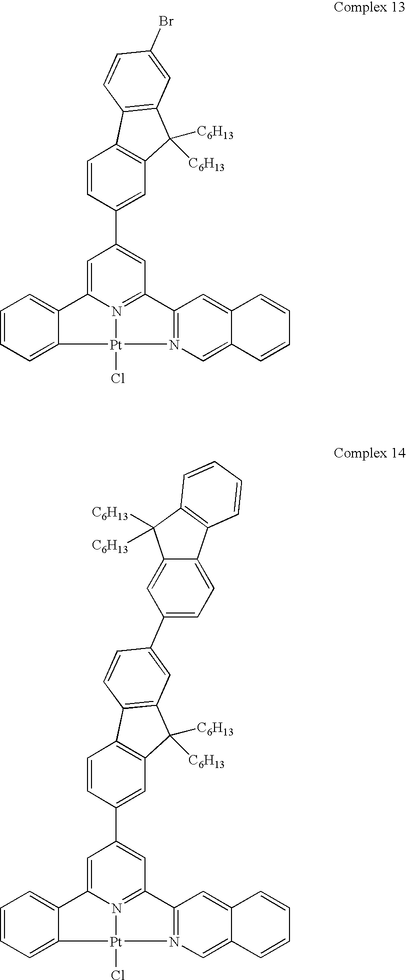

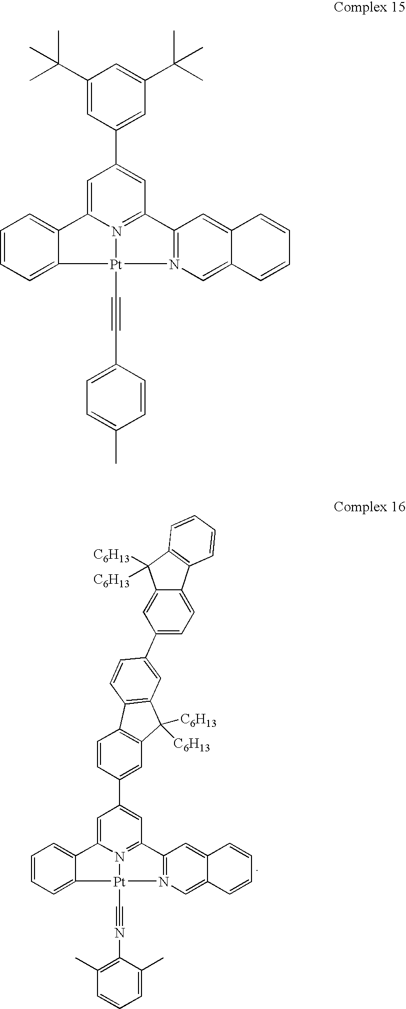

3. An organic light-emitting device (OLED) including a light-emitting material containing one or more of the organometallic complexes set forth in claim 1.

4. The organometallic complexes as set forth in claim 3, wherein the complex has one of the following structures:

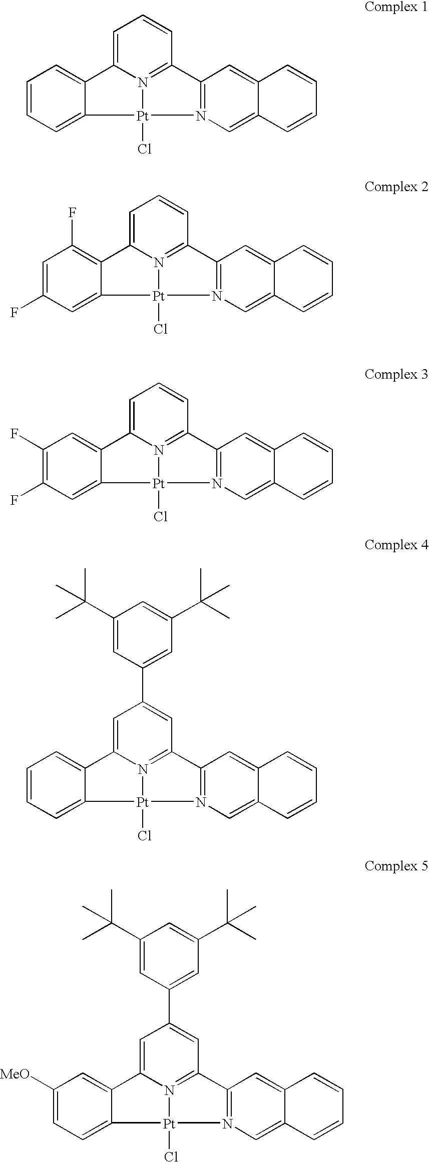

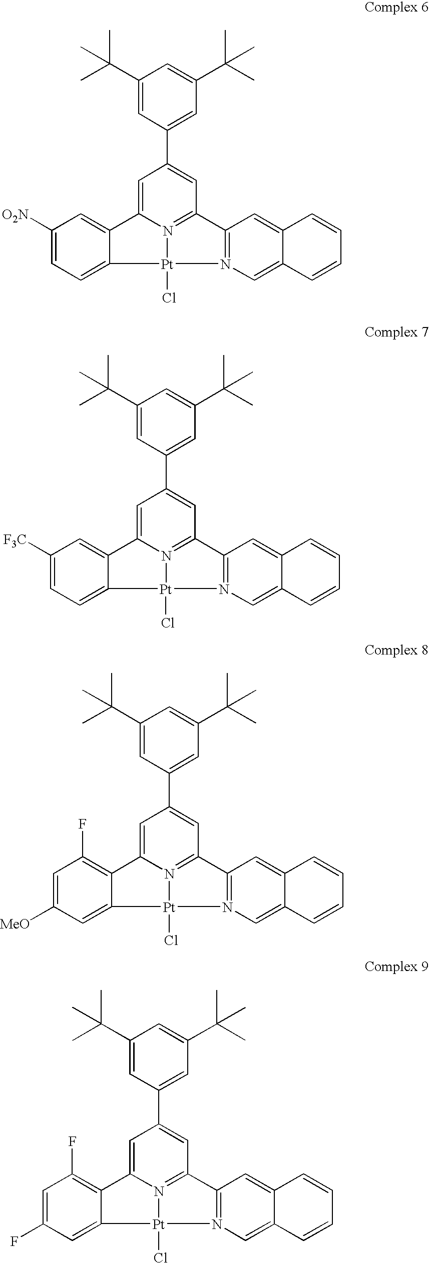

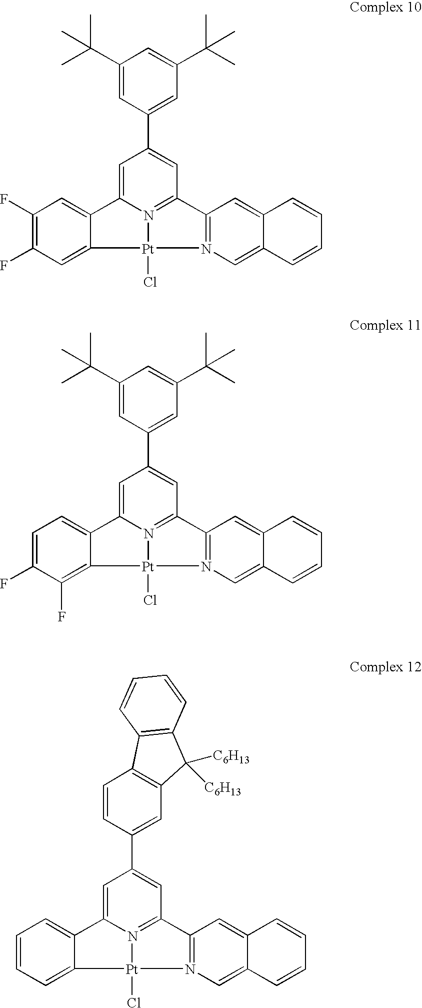

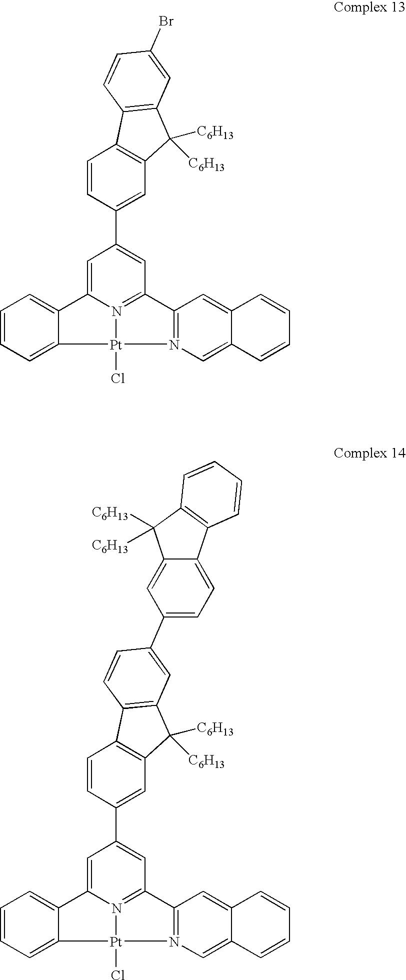

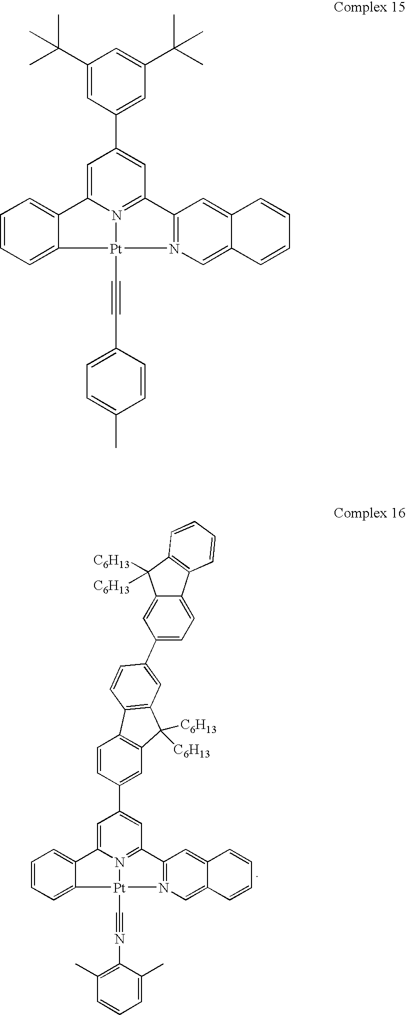

5. An organic light-emitting device described in claim 3, wherein the organometallic complex is applied as a layer in the device by thermal deposition.

6. An organic light-emitting device described in claim 3, wherein the organometallic complex is applied as a layer in the device by spin coating.

7. An organic light-emitting device as set forth in claim 3, wherein the organometallic complex is applied as a layer in the device by ink-jet printing.

8. An organic light-emitting device, wherein the device emits a single color when an electric current is applied to a layer containing one or more of the organometallic complexes set forth in claim 1.

9. An organic light-emitting device as set forth in claim 3, wherein the device emits white light when an electric current is applied to a layer containing one or more of the organometallic complexes set forth in claim 1 and to one or more emission components from other emitting materials.

10. An organic light-emitting device comprising:
a transparent substrate;
a transparent electrode;
a hole transporting layer;
an emissive layer comprising a host material doped with least one of the organometallic complexes as set forth in claim 1;
a hole blocking layer;
an electron transporting layer;
a charge injection layer; and
an electrode.

11. An organic light-emitting device comprising:
a transparent substrate;
a transparent electrode;
a hole transporting layer;
an emissive layer comprising a host material doped with at least one of the organometallic complexes set forth in claim 2;
a hole blocking layer;
a charge injection layer; and
an electrode.

12. An organic light-emitting device comprising:
a transparent substrate;
a transparent electrode;
a hole transporting layer;
an emissive layer comprising a host material doped with at least one of the organometallic complexes as set forth in claim 4;
a hole transporting layer;
an emissive layer comprising a blue to sky blue emitting material;
a hole blocking layer;
a charge injection layer; and
an electrode.

13. A method of making an organometallic complex having a chemical structure according to claim 1 comprising:
reacting a ĈN̂N ligand identified as Structure II below: 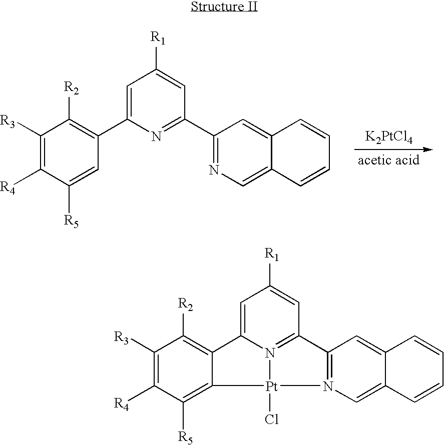
wherein R₁-R₅ are independently hydrogen, halogen, hydroxyl, an unsubstituted alkyl, a substituted alkyl, cycloalkyl, an unsubstituted aryl, a substituted aryl, acyl, alkoxy, acyloxy, amino, nitro, acylamino, aralkyl, cyano, carboxyl, thio, styryl, aminocarbonyl, carbamoyl, aryloxycarbonyl, phenoxycarbonyl, or an alkoxycarbonyl group, with potassium tetrachloroplatinate (K₂PtCl₄), using acetic acid as solvent.

14. A compound having the following structure: 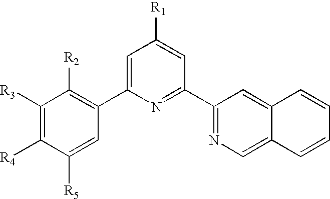
wherein R₁-R₅ are independently hydrogen, halogen, hydroxyl, an unsubstituted alkyl, a substituted alkyl, cycloalkyl, an unsubstituted aryl, a substituted aryl, acyl, alkoxy, acyloxy, amino, nitro, acylamino, aralkyl, cyano, carboxyl, thio, styryl, aminocarbonyl, carbamoyl, aryloxycarbonyl, phenoxycarbonyl, or an alkoxycarbonyl group.

15. A compound having one of the following structures:

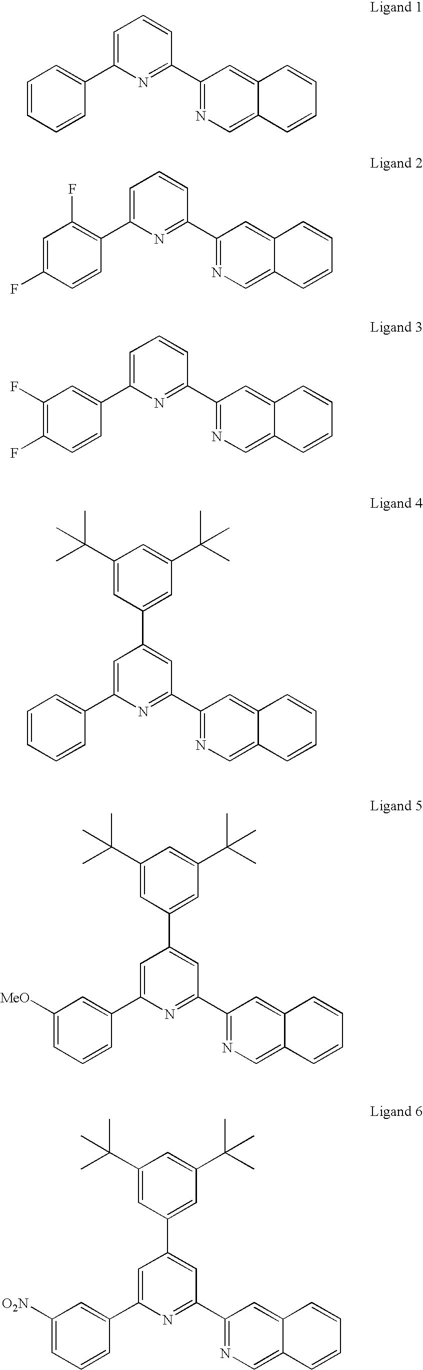

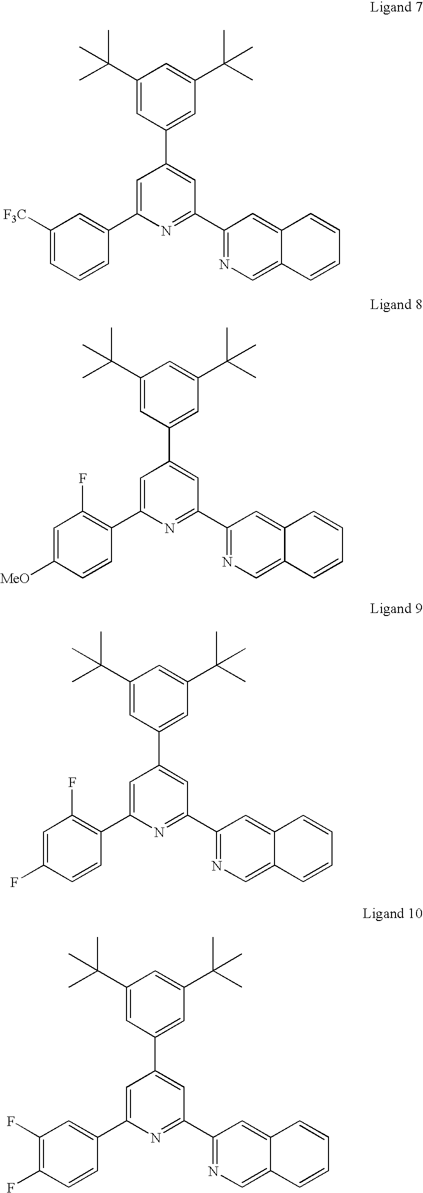

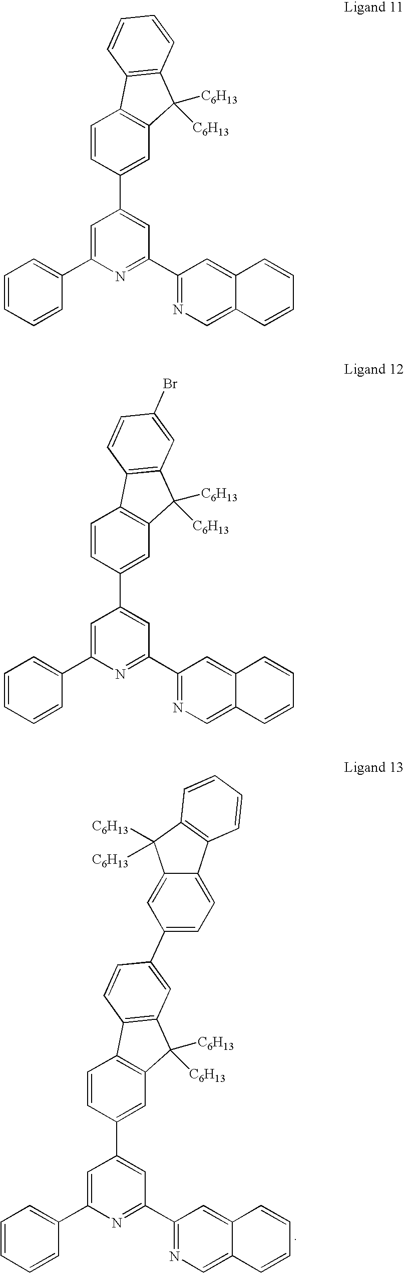

16. A method for making an organic light emitting device comprising steps of:
reacting a ligand having the following structure: 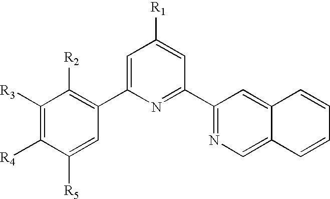
wherein R₁-R₅ are independently hydrogen, halogen, hydroxyl, an unsubstituted alkyl, a substituted alkyl, cycloalkyl, an unsubstituted aryl, a substituted aryl, acyl, alkoxy, acyloxy, amino, nitro, acylamino, aralkyl, cyano, carboxyl, thio, styryl, aminocarbonyl, carbamoyl, aryloxycarbonyl, phenoxycarbonyl, or an alkoxycarbonyl group, with potassium tetrachloroplatinate (K₂PtCl₄), to obtain a platinum complex; and applying a layer of the complex as an emission layer of a light emitting device or doping the platinum complex in an emission layer of a light emitting device.
